(19) United States
(12) Patent Application Publication
(10) Pub. No.: US 2025/0170532 A1
(43) Pub. Date: May 29, 2025

(54) BETA-CYCLODEXTRIN THIN FILM COMPOSITE MEMBRANES FOR NANOFILTRATION

(71) Applicant: KING FAHD UNIVERSITY OF PETROLEUM AND MINERALS, Dhahran (SA)

(72) Inventors: Umair BAIG, Dhahran (SA); Shehzada Muhammad Sajid JILLANI, Dhahran (SA); Abdul WAHEED, Dhahran (SA)

(73) Assignee: KING FAHD UNIVERSITY OF PETROLEUM AND MINERALS, Dhahran (SA)

(21) Appl. No.: 18/519,966

(22) Filed: Nov. 27, 2023

(51) Int. Cl. B01D 69/12; B01D 61/02; B01D 67/00; B01D 69/02; B01D 69/10; B01D 71/08; B01D 71/68; C02F 1/44; C02F 103/34

(52) U.S. Cl. CPC B01D 69/1251; B01D 61/027; B01D 67/0006; B01D 67/0013; B01D 69/02; B01D 69/107; B01D 69/1214; B01D 71/08; B01D 71/68; C02F 1/442; B01D 2323/30; B01D 2325/02833; B01D 2325/02834; B01D 2325/06; C02F 2103/343

(57) ABSTRACT

A filtration membrane, including (in the following order) a thermoplastic substrate, a first layer including a polysulfone, a second layer including units of a glucose-derived polysaccharide reacted with units of a tetramine and units of a phthaloyl chloride. The units of the tetramine and the units of the phthaloyl chloride are reacted to form a polyamide (PA) and the units of glucose-derived polysaccharide are covalently bonded to the PA through reacted units of the phthaloyl chloride. A method of nanofiltration using the filtration membrane.

### STATEMENT REGARDING PRIOR DISCLOSURE BY THE INVENTORS

Aspects of the present disclosure are described in Baig, U., Jillani, S. M. S., and Waheed, A., “Decoration of β-Cyclodextrin and Tuning Active Layer Chemistry Leading to Nanofiltration Membranes for Desalination and Wastewater Decontamination” published in Volume 13, Issue 5, Membranes, which is incorporated herein by reference in its entirety.

### STATEMENT OF ACKNOWLEDGEMENT

Support provided by the Interdisciplinary Research Center for Membranes and Water Security, King Fahd University of Petroleum and Minerals, Saudi Arabia, through Project INWM2311 is gratefully acknowledged.

### BACKGROUND

### Technical Field

The present disclosure is directed towards a nanofiltration membrane, more particularly, a multi-layered thin film composite membrane including a polysulfone and a polysaccharide reacted with a tetramine and a phthaloyl chloride, and a method nanofiltration thereof.

### Description of Related Art

The “background” description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Clean water is a challenge for the rapidly growing human population and industrialization of the world. Although technologies have developed over the past years for treating contaminated water resources, which include seawater and domestic and industrial wastewater. Among the various treatment technologies, membrane-based water treatment has shown potential. Membrane-based separations have several advantages over conventional treatment methods. The membrane-based separations offer ease of operation and tunability, are less energy intensive, and have little carbon footprint and a clean output product. Although some of the desalination technologies, such as capacitive deionization (CDI), have been shown to be energy efficient, desalination technologies have certain challenges, such as low electrosorption capacity, slow electrosorption rate, and poor cycling stability. These challenges continue to be addressed to enhance the prospects of transferring CDI to an industrial scale, where the potential of MXenes has been explored.

Thin film composite (TFC) membranes have been fabricated through interfacial polymerization (IP) on an ultrafiltration (UF) support. IP reaction is generally carried out between an aqueous diamine, such as meta-phenylenediamine (MPD), and a non-aqueous (n-hexane) solution of trimesoyl chloride (TMC). In the case of nanofiltration (NF) membranes, a TFC polyamide membrane is fabricated through IP using piperazine (PIP) as an aqueous amine crosslinked with TMC. Improvement of the performance of the membranes have been explored since the discovery and success of the polyamide TFC membranes in desalination.

Many strategies, such as tuning the active layers of the polyamide membranes during IP, have been explored. It has been shown that the use of different materials, such as metal-organic frameworks (MOFs), covalent organic frameworks (COFs), nanomaterials (NMs), carbon nanotubes (CNTs), zeolites, porous polymers, and graphene, enhance the performance of the TFC polyamide membranes [Ahmad, N. N. R.; Mohammad, A. W.; Mahmoudi, E.; Ang, W. L.; Leo, C. P.; Teow, Y. H. An Overview of the Modification Strategies in Developing Antifouling Nanofiltration Membranes. Membranes (Basel). 2022, 12, 1276].

An NF membrane was fabricated by using PIP and TMC, while 3,5-diaminobenzoic acid (DABA) was an additive in the active layer of the NF membrane. The inclusion of DABA in the NF membrane resulted in an increase of 20% in water flux during filtration experiments. This increase in permeate flux was attributed to the presence of an additional —COOH group on the DABA, which developed a highly hydrophilic membrane [Ahmad, A. L.; Ooi, B. S.; Wahab Mohammad, A.; Choudhury, J. P. Development of a Highly Hydrophilic Nanofiltration Membrane for Desalination and Water Treatment. Desalination 2004, 168, 215-221]. Similarly, UiO-66-NH₂ was loaded with Ag nanoparticles, and the resulting Ag@UiO-66-NH₂ was incorporated in the polyamide active layer during IP. The resultant Ag@UiO-66-NH₂ decorated membrane showed antifouling performance with a flux recovery ratio of 95.6%. Moreover, due to the presence of Ag metal, the membrane showed an antibacterial rate of >95%. Due to the porous nature of Ag@UiO-66-NH₂, the membrane showed a permeate flux of 47.3 LMH.

Similarly, macrocyclic compounds have recently been used during the fabrication of NF membranes. The most commonly used macrocycles are crown ethers, cyclenes, cyclodextrins (CDs), calixarenes, cucurbiturils (CBs), and the like. Macrocycles have been explored due to their salient features, such as molecular recognition and multiple functionalities. These macrocycles develop different interactions, such as hydrogen bonding, ionic interactions, and hydrophobic interactions. Among these macrocycles, CDs have been used in several separation applications owing to their dual nature of having a hydrophobic inner cavity and an outer hydrophilic surface due to several hydroxyl (—OH) groups on glucopyranose units. Due to these dual features, CDs have been used in different applications such as water treatment, chromatography, catalysis, and biomedical applications. Beta-cyclodexrin (β-CD, BCD) polymers are used for the removal of organic micro-pollutants, such as pesticides, pharmaceuticals, and plastic components [Alsbaiee, A.; Smith, B. J.; Xiao, L.; Ling, Y.; Helbling, D. E.; Dichtel, W. R. Rapid Removal of Organic Micropollutants from Water by a Porous β-Cyclodextrin Polymer. Nature 2016, 529, 190-194]. Similarly, BCD polymers have been used for the absorption of organic molecules from water [Hemine, K.; Lukasik, N.; Gazda, M.; Nowak, I. β-Cyclodextrin-Containing Polymer Based on Renewable Cellulose Resources for Effective Removal of Ionic and Non-Ionic Toxic Organic Pollutants from Water. J. Hazard. Mater. 2021, 418, 126286]. Hence, BCD has potential to be explored for the rejection of a variety of pollutants from contaminated feeds.

Other macrocycles, such as cyclene, have been used for the fabrication of polyamide NF membranes for rejecting divalent ions. A NF membrane made through IP using cyclene and TMC on an ultrafiltration (UF) polysulfone (PSf) support showed salt rejections of 97%, 96.3%, and 96.2% for Na₂SO₄, MgCl₂, and MgSO₄, respectively [Wang, M.; Li, M.; Fei, Z.; Li, J.; Ren, Z.; Hou, Y. Synergistic Regulation of Macrocyclic Polyamine-Based Polyamide Nanofiltration Membranes by the Interlayer and Surfactant for Divalent Ions Rejection and Mono-/Di-Ions Sieving. Desalination 2022, 544, 116131].

Another aspect of NF membranes is the tuning of the polyamide active layer by altering the chemistry of the monomers used during IP. The pore structure of the NF membranes has been tuned by selecting different combinations of aqueous amines and non-aqueous cross-linkers. The microstructure of the polyamide active layer can be tuned by enhancing the inter-pore connectivity of the polyamide active layer. A highly dense polyarylate layer having bisphenol monomers with a rigid structure instead of PIP showed a higher organic solvent permeate flux and gas permeation [Jimenez-Solomon, M. F.; Song, Q.; Jelfs, K. E.; Munoz-Ibanez, M.; Livingston, A. G. Polymer Nanofilms with Enhanced Microporosity by Interfacial Polymerization. Nat. Mater. 2016, 15, 760-767]. A co-polyamide membrane was developed by adjusting the ratio of bisphenol and PIP, leading to a poly(ester-amide) active layer with enhanced interconnectivity [Jiang, C.; Tian, L.; Hou, Y.; Niu, Q. J. Nanofiltration Membranes with Enhanced Microporosity and Inner-Pore Interconnectivity for Water Treatment: Excellent Balance between Permeability and Selectivity. J. Memb. Sci. 2019, 586, 192-201]. A polyamide active layer with a hydrolyzable side-chain by using PIP derivatives with —COOMe and —COOC₂H₅ side chains was developed [Wang, K.; Fu, W.; Wang, X.; Xu, C.; Gao, Y.; Liu, Y.; Zhang, X.; Huang, X. Molecular Design of the Polyamide Layer Structure of Nanofiltration Membranes by Sacrificing Hydrolyzable Groups toward Enhanced Separation Performance. Environ. Sci. Technol. 2022, 56, 17955-17964]. The hydrolysis of the side-chain esters led to —COOH groups, causing an increase in permeance from 5.7 LMH/bar to 12.9 LMH/bar. The molecular weight cutoff (MWCO) revealed a decrease in pore size from 358 Da to 270 Da and an active layer reduction in thickness from 44.7 nm to 20.7 nm, which led to higher permeance. Altering the chemistry of the active layer during IP is a way to design and develop new membranes with enhanced performance for the rejection of salts and removal of micro-pollutants, such as pharmaceuticals [Waheed, A.; Baig, U.; Aljundi, I. H. Fabrication of Molecularly Porous Hyper-Cross-Linked Thin Film Composite Nanofiltration Membrane Using Cyclic Amine and Linear Cross-Linker for Highly Selective Organic Solvent Nanofiltration. Colloid Interface Sci. Commun. 2021, 45, 100530].

Although there are improvements in membrane performance, most conventional membranes have been prepared using a set of traditional monomers, such as diamines MPD and PIP, crosslinked with TMC. There is a need to explore different sets of monomers that could open new routes of NF membranes prepared through IP. Accordingly, an objective of the present disclosure is to describe a filtration membrane using unconventional linear aliphatic amines along with the incorporation of macrocyclic porous molecules to enhance the NF of the membrane.

### SUMMARY

In an exemplary embodiment, a filtration membrane is disclosed. The filtration membrane includes (in the following order) a thermoplastic substrate, a first layer including a polysulfone (PSf), a second layer including units of a glucose-derived polysaccharide reacted with units of a tetramine, and units of a phthaloyl chloride. Further, the units of the tetramine and the units of the phthaloyl chloride are reacted to form a polyamide (PA), and the units of glucose-derived polysaccharide are covalently bonded to the polyamide through reacted units of the phthaloyl chloride.

In some embodiments, the thermoplastic substrate is a polyester terephthalate.

In some embodiments, the glucose-derived polysaccharide is a beta-cyclodextrin (BCD).

In some embodiments, the tetramine is N,N′-bis(3-aminopropyl)ethylenediamine.

In some embodiments, the phthaloyl chloride is terephthalyol chloride (TPC) or trimesoyl chloride (TMC).

In some embodiments, a reacted hydroxyl group of the glucose-derived polysaccharide is cross-linked to a reacted secondary amine of the reacted units of the tetramine in the polyamide through a reacted unit of the phthaloyl chloride.

In some embodiments, the membrane has a water contact angle of 700 to 85°.

In some embodiments, the membrane has an average surface roughness of 5 nanometers (nm) to 45 nm.

In some embodiments, the second layer is in the form of nanoparticles with a diameter of 2 nm to 50 nm.

In some embodiments, the nanoparticles form ridges 1 micrometers (μm) to 3 μm in width and 1 μm to 20 μm in length and valleys 0.2 μm to 2 μm in width and 1 μm to 20 μm in length.

In some embodiments, the second layer is porous with pores 100 nm to 1000 nm in diameter.

In some embodiments, the membrane comprises carbon in an amount of 65 wt. % to 75 wt. %, oxygen in an amount of 10 wt. % to 15 wt. %, sulfur in an amount of 5 wt. % to 10 wt. %, and nitrogen in an amount of 5 wt. % to 15 wt. % based on a total weight of the membrane.

In another exemplary embodiment, a method for nanofiltration is disclosed. The method includes contacting an aqueous composition with the filtration membrane. The aqueous composition comprises at least water and one or more pollutants, and the pollutants comprise one or more salts and one or more pharmaceuticals. Furthermore, the method includes passing a permeate through the filtration membrane to obtain a purified composition having a reduced amount of pollutants.

In some embodiments, the method further includes wetting the filtration membrane with a polar solvent before contacting.

In some embodiments, the membrane has a permeate flux of 15 L m⁻² h⁻¹ to 75 L m⁻² h⁻¹ at a pressure of 5 bar.

In some embodiments, the aqueous composition comprises water and one or more salts, and has a rejection percentage of 65% to 95% by weight based on an initial weight of the one or more salts at a pressure of 15 bar.

In some embodiments, the aqueous composition comprises water and one or more pharmaceuticals, and has a rejection percentage of 65% to 95% by weight based on an initial weight of the one or more pharmaceuticals at a pressure of 15 bar.

In yet another exemplary embodiment, a method of fabrication of the membrane is disclosed. The method includes casting the polysulfone (PSf) on the thermoplastic substrate to form a first film, submerging the first film into an aqueous amine solution to form a second film. The aqueous amine solution comprises water, the tetramine, and the glucose-derived polysaccharide. Furthermore, the method includes dipping the second film in a crosslinker solution, the crosslinker solution comprises an organic solvent and the phthaloyl chloride to form the filtration membrane; and drying the filtration membrane.

In some embodiments, the dipping is from 0.5 minutes (min) to 5 min.

In some embodiments, the phthaloyl chloride is a terephthalyol chloride, and the membrane has a rejection percentage of 80% to 95% by weight based on an initial weight of one or more pollutants at a pressure of 15 bar.

These and other aspects of the non-limiting embodiments of the present disclosure will become apparent to those skilled in the art upon review of the following description of specific non-limiting embodiments of the disclosure in conjunction with the accompanying drawings. The foregoing general description of the illustrative present disclosure and the following detailed description thereof are merely exemplary aspects of the teachings of this disclosure and are not restrictive.

### BRIEF DESCRIPTION OF DRAWINGS

A more complete appreciation of this disclosure (including alternatives and/or variations thereof) and many of the attendant advantages thereof will be readily obtained as the same becomes better understood by reference to the following detailed description when considered in connection with the accompanying drawings, wherein:

FIG. 1A is a flow chart depicting a method of nanofiltration (NF), according to certain embodiments;

FIG. 1B is a flow chart depicting a method of making the NF membrane, according to certain embodiments;

FIG. 1C is a schematic illustration depicting different stages of fabrication of thin film composite (TFC) NF membranes, according to certain embodiments;

FIG. 2 is a schematic representation depicting the proposed reaction and structure of the active layer using tetramine, terephthalyol chloride (TPC), and beta-cyclodextrin (BCD), according to certain embodiments;

FIG. 3A shows attenuated total reflectance Fourier-transform infrared (ATR-FTIR) spectra of the polysulfone (PSf) support, the BCD-TA-TPC@PSf membrane, and the BCD-TA-trimesoyl chloride (TMC)@PSf membrane, according to certain embodiments;

FIG. 3B depicts a fingerprint region of ATR-FTIR spectra the PSf support, the BCD-TA-TPC@PSf membrane, and the BCD-TA-TMC@PSf membrane, according to certain embodiments;

FIG. 4 shows variations in water contact angles (WCAs) of the PSf support, the BCD-TA-TPC@PSf membrane, and the BCD-TA-TMC@PSf membrane, according to certain embodiments;

FIG. 5A shows a 2D-atomic force microscopy (AFM) topographical image of the PSf support, according to certain embodiments;

FIG. 5B shows 3D-AFM topographical image of the PSf support, according to certain embodiments;

FIG. 5C shows 2D-AFM topographical image of the BCD-TA-TPC@PSf membrane, according to certain embodiments;

FIG. 5D shows 3D-AFM topographical image of the BCD-TA-TPC@PSf membrane, according to certain embodiments;

FIG. 5E shows 2D-AFM topographical image of the BCD-TA-TMC@PSf membrane, according to certain embodiments;

FIG. 5F shows 3D-AFM topographical image of the BCD-TA-TMC@PSf membrane, according to certain embodiments;

FIG. 6A shows scanning electron microscopy (SEM) micrograph of the PSf support at a scale of 5 micrometers (m), according to certain embodiments;

FIG. 6B shows SEM micrograph of the PSf support at a scale of 1 μm, according to certain embodiments;

FIG. 6C shows SEM micrograph of the PSf support at a scale of 500 nanometers (nm), according to certain embodiments;

FIG. 6D shows SEM micrograph of the BCD-TA-TPC@PSf membrane at a scale of 5 μm, according to certain embodiments;

FIG. 6E shows SEM micrograph of the BCD-TA-TPC@PSf membrane at a scale of 1 μm, according to certain embodiments;

FIG. 6F shows SEM micrograph of the BCD-TA-TPC@PSf membrane at a scale of 500 nm, according to certain embodiments;

FIG. 6G shows SEM micrograph of the BCD-TA-TMC@PSf membrane at a scale of 5 μm, according to certain embodiments;

FIG. 6H shows SEM micrograph of the BCD-TA-TMC@PSf membrane at a scale of 1 μm, according to certain embodiments;

FIG. 6I shows SEM micrograph of the BCD-TA-TMC@PSf membrane at a scale of 500 nm, according to certain embodiments;

FIGS. 7A-7B show SEM/energy-dispersive X-ray spectroscopic (EDX/EDS) analysis of the PSf support, according to certain embodiments;

FIGS. 7C-7D show SEM/EDX analysis of the BCD-TA-TPC@PSf membrane, according to certain embodiments;

FIGS. 7E-7F show SEM/EDX analysis of the BCD-TA-TMC@PSf membrane, according to certain embodiments;

FIG. 8A shows an EDS-layered image of the PSf support, according to certain embodiments;

FIG. 8B shows elemental mapping analysis depicting carbon distributed in the PSf support, according to certain embodiments;

FIG. 8C shows elemental mapping analysis depicting oxygen distributed in the PSf support, according to certain embodiments;

FIG. 8D shows elemental mapping analysis depicting sulfur distributed in the PSf support, according to certain embodiments;

FIG. 8E shows EDS-layered image of the BCD-TA-TPC@PSf membrane, according to certain embodiments;

FIG. 8F shows elemental mapping analysis depicting carbon distributed in the BCD-TA-TPC@PSf membrane, according to certain embodiments;

FIG. 8G shows elemental mapping analysis depicting nitrogen distributed in the BCD-TA-TPC@PSf membrane, according to certain embodiments;

FIG. 8H shows elemental mapping analysis depicting oxygen distributed in the BCD-TA-TPC@PSf membrane, according to certain embodiments;

FIG. 8I shows elemental mapping analysis depicting sulfur distributed in the BCD-TA-TPC@PSf membrane, according to certain embodiments;

FIG. 8J shows EDS-layered image of the BCD-TA-TMC@PSf membrane, according to certain embodiments;

FIG. 8K shows elemental mapping analysis depicting carbon distributed in the BCD-TA-TMC@PSf membrane, according to certain embodiments;

FIG. 8L shows elemental mapping analysis depicting nitrogen distributed in the BCD-TA-TMC@PSf membrane, according to certain embodiments;

FIG. 8M shows elemental mapping analysis depicting oxygen distributed in the BCD-TA-TMC@PSf membrane, according to certain embodiments;

FIG. 8N shows elemental mapping analysis depicting sulfur distributed in the BCD-TA-TMC@PSf membrane, according to certain embodiments;

FIG. 9 is a bar graph depicting the variation of permeate flux of BCD-TA-TPC@PSf membranes and the BCD-TA-TMC@PSf membranes synthesized at various crosslinking times, at varying applied transmembrane pressures, according to certain embodiments;

FIG. 10 is a bar graph depicting the rejection profile of different salts by the BCD-TA-TPC@PSf membranes and the BCD-TA-TMC@PSf membranes synthesized at various crosslinking times at 15 bar transmembrane pressure, according to certain embodiments;

FIG. 11 is a bar graph showing the rejection profile of different micro-pollutants by the BCD-TA-TPC@PSf membranes and the BCD-TA-TMC@PSf membranes synthesized at various crosslinking times at 15 bar transmembrane pressure, according to certain embodiments;

FIG. 12A is a bar graph of variation of permeate flux as a function of applied feed pressure for the BCD-TA-TPC@PSf membrane and the BCD-TA-TMC@PSf membrane, according to certain embodiments;

FIG. 12B is a bar graph depicting the rejection percentage of salts with the BCD-TA-TPC@PSf membrane and the BCD-TA-TMC@PSf membrane, according to certain embodiments;

FIG. 13A depicts the chemical structure of micro-pollutants (pharmaceuticals) present in the feed, according to certain embodiments; and

FIG. 13B is a bar graph depicting the rejection performance of the BCD-TA-TPC@PSf membrane and the BCD-TA-TMC@PSf membrane against the pharmaceutical micro-pollutants, according to certain embodiments.

### DETAILED DESCRIPTION

In the following description, it is understood that other embodiments may be utilized, and structural and operational changes may be made without departure from the scope of the present embodiments disclosed herein.

Reference will now be made to specific embodiments or features, examples of which are illustrated in the accompanying drawings. In the drawings, whenever possible, corresponding or similar reference numerals will be used to designate identical or corresponding parts throughout the several views. Moreover, references to various elements described herein are made collectively or individually when there may be more than one element of the same type. However, such references are merely exemplary in nature. It may be noted that any reference to elements in the singular may also be constructed to relate to the plural and vice-versa without limiting the scope of the disclosure to the exact number or type of such elements unless set forth explicitly in the appended claims.

When describing the present disclosure, the terms used are to be construed in accordance with the following definitions, unless a context dictates otherwise.

Embodiments of the present disclosure will now be described more fully hereinafter with reference to the accompanying drawings wherever applicable, in that some, but not all embodiments of the disclosure are shown.

As used herein, the words “a,” “an,” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

As used herein, the term “nanoparticles” refers to particles having a particle size of 1 nanometers (nm) to 500 nm within the scope of the present disclosure. The nanoparticles (NPs) may exist in various morphological shapes, such as nanowires, nanocrystals, nanorectangles, nanotriangles, nanopentagons, nanohexagons, nanoprisms, nanodisks, nanocubes, nanoribbons, nanoblocks, nanobeads, nanotoroids, nanodiscs, nanobarrels, nanogranules, nanowhiskers, nanoflakes, nanofoils, nanopowders, nanoboxes, nanostars, tetrapods, nanobelts, nano-urchins, nanofloweres, the like, and mixtures thereof.

As used herein, the term “porosity” refers to a measure of the void or vacant spaces within a material. Porosity is a ratio of the void or vacant space, sometimes referred to as pore volume, to a bulk volume. Porosity may be referred to as a fraction or a percentage.

As used herein, the term “particle size” refers to the length or longest dimension of a particle.

As used herein, the term “pore size” refers to the length or longest dimension of a pore opening.

As used herein, the term “membrane” as used herein refers to a porous structure that is capable of separating components of a homogeneous or heterogeneous fluid. A membrane may be a layer of varying thickness of semi-permeable material that may be used for solute separation as a transmembrane pressure is applied across the membrane. A degree of selectivity may be based on membrane composition, charge, and porosity. Membranes may have symmetric or asymmetric pores, wherein a membrane with asymmetric pores have variable pore diameters. Membranes may be used for microfiltration, ultrafiltration, nanofiltration, and reverse osmosis process. In particular, “pores” in the sense of the present disclosure indicate voids allowing fluid communication between different sides of the structure. Pores may have a varying pore size, pore size distribution, and pore morphology, such as pore shape and surface roughness. The pores may be made up of a network of interconnected channels. More particular in use when a homogeneous or heterogeneous fluid is passed through the membrane, some components of the fluid can pass through the pores of the membrane into a “permeate stream,” while some components of the fluid can be retained by the membrane and can thus accumulate in a “retentate,” and/or some components of the fluid can be rejected by the membrane into a “rejection stream.” The homogeneous or heterogeneous fluid that enters the membrane may be referred to herein as a “feed stream” or a “feed.” Membranes can be of various thicknesses, with homogeneous or heterogeneous structures. Membranes can be in the form of flat sheets or bundles of hollow fibers. Membranes can also be in various configurations, including but not limited to spiral wound, tubular, hollow fiber, and other configurations identifiable to a skilled person upon a reading of the present disclosure. Membranes can also be classified according to their pore diameter. Membranes can be neutral or charged, and particle transport can be active or passive. The latter can be facilitated by pressure, concentration, and chemical or electrical gradients of the membrane process.

As used herein, “filtration” refers to the mechanical or physical operation or process that can be employed for the separation of constituents of homogeneous or heterogeneous solutions. Filtration may use a filter medium to separate components of homogeneous and heterogenous solutions. The filter medium may be a physical separator, such as a membrane, a chemical separator or gradient, an electrical separator or gradient, and any separator or gradient known in the art for separating solutions. Filtration may be used to separate solids from liquids, solids from gases, and/or liquids from other liquids. Filtration may be gravity-driven, pressure-driven, and/or vacuum-driven. Types of filtration can be categorized by the estimated sizes of materials to be separated and can involve particle filtration (>10 μm), microfiltration (MF) (0.1-10 μm), ultrafiltration (UF) (0.01-0.1 μm), nanofiltration (NF) (0.001-0.01 μm), reverse osmosis (RO) (<0.001 μm), and any filtration known in the art.

As used herein, “surface roughness” refers to a parameter establishing the performance of the membrane. Rougher surfaces may accumulate foulants in valleys, reducing permeate quality and flow rate.

As used herein, “water contact angle (WCA)” refers to a measure of the wettability of a solid surface. Hydrophobic solids have a contact angle above 90° (indicative of poor wetting), and hydrophilic solids have a contact angle below 90° (indicative of water-loving). The contact angle may be used for gauging the hydrophobicity, hydrophilicity, and/or extent of cleanliness of a surface.

As used herein, “pollutant” refers to a substance introduced into the environment (i.e., air, gas, water, liquid, and the like) that has undesired, or even detrimental, consequences.

As used herein, “flux” refers to a metric for comparing, scaling, and assessing the general performance of a membrane. It is defined as the permeate flow per unit of time and membrane surface area, commonly expressed as liters per square meter per hour (L m⁻² h⁻¹) (LMH).

Aspects of the present disclosure are directed to a filtration membrane and a method of nanofiltration thereof. The filtration membrane includes (in the following order) a thermoplastic substrate, a first layer including a polysulfone (PSI), a second layer including units of a glucose-derived polysaccharide reacted with units of a tetramine and units of a phthaloyl chloride. Further, the units of the tetramine and the units of the phthaloyl chloride are reacted to form a polyamide (PA), and the units of the glucose-derived polysaccharide are covalently bonded to the PA through reacted units of the phthaloyl chloride. To further tune the structure of the active layers, the time duration of interfacial polymerization (IP) was varied from 1, 2, and 3 minutes. The membranes were characterized by scanning electron microscopy (SEM), atomic force microscopy (AFM), water contact angles (WCAs), attenuated total reflectance Fourier-transform infrared (ATR-FTIR) spectroscopy, elemental mapping, and energy dispersive (EDX) analysis. The six fabricated membranes were tested for their ability to reject divalent and monovalent ions, followed by the rejection of micro-pollutants (pharmaceuticals).

A filtration membrane is described. The filtration membrane, also referred to as a membrane, includes a thermoplastic substrate. It is desirable for the thermoplastic substrate to possess good mechanical and thermal properties. Also, the thermoplastic substrate should demonstrate high resistance to chemicals, such as aromatic hydrocarbons, ketones, ethers, and esters. The thermoplastic substrate is an aggregate material including a polymer component (thermoplastic polymer) configured to strengthen the membrane structure.

The thermoplastic substrate includes one or more thermoplastic polymers. Suitable examples of thermoplastic polymers include, but are not limited to, polypropylene (PP), polyamide (PA), polyacrylonitrile (PAN), polycarbonate (PC), high-density polyethylene (HDPE), low-density polyethylene (LDPE), polybutylene terephthalate (PBT), polyethylene terephthalate (PET), polyester terephthalate, polystyrene (PS), polyether ether ketone (PEEK), polyphenylene sulfide (PPS), polyetherimide (PEI), polyamide-imide (PAI), polyacrylic acid (PAA), acrylonitrile butadiene styrene (ABS), polylactic acid (PLA), polyvinyl chloride (PVC), polyurethanes (PUR), polyvinylidene fluoride (PVDF), polytetrafluoroethylene (Teflon), the like, and/or a mixture thereof. In some embodiments, blends of thermoplastic polymers may be used as well. In a preferred embodiment, the thermoplastic substrate is a polyester terephthalate, preferably a polyethylene terephthalate (PET).

In some embodiments, the thermoplastic substrate has a thickness of 2-200 μm, preferably 10-190 μm, preferably 20-180 μm, preferably 40-160 μm, preferably 50-150 μm, preferably 70-140 μm, preferably 80-130 μm, or preferably 100-120 μm.

The membrane further includes a first layer including a polysulfone (PSf). Polysulfones are a group of polymers, including a sulfone group and alkyl- and/or aryl-groups. The polysulfone polymer may be polysulfone (PSf), polyethersulfone (PES), polyphenylene sulfone (PPSU), poly(arylene sulfone) (PAS), poly(bisphenol-A sulfone), and/or some derivative of PSf. The polysulfone may be a mixture of polysulfone polymers. The PSf polymer may also be called a polyaryl sulfone or a polyarylethersulfone. In a preferred embodiment, the polysulfone polymer is PSf. In some embodiments, other polymers such as polyvinyl chloride, polyvinylidene chloride, polyacrylonitrile, high impact polystyrene, acrylonitrile butadiene styrene, polyethylene/acrylonitrile butadiene styrene, polycarbonate/acrylonitrile butadiene styrene, acrylic polymers, polybutadiene, polyisoprene, polyacetylene, silicones, synthetic rubbers, the like, and copolymers and mixtures thereof may be used as well in addition to and/or instead of PSf.

In some embodiments, the first layer may have a thickness of 5-500 μm, preferably 10-400 μm, preferably 20-350 μm, preferably 30-300 μm, preferably 40-250 μm, preferably 50-200 μm, preferably 70-150 μm, preferably 80-140 μm, or preferably 100-120 μm. In embodiments the first layer has a thickness at least 20% less than the thickness of the thermoplastic substrate, preferably 20-30%, 30-40%, 50-70% or 75-90% less than the thickness of the thermoplastic substrate.

The membrane further includes a second layer, including units of a glucose-derived polysaccharide reacted with units of a tetramine and units of a phthaloyl chloride. Suitable examples of glucose-derived polysaccharide include, but are not limited to, cyclodextrin, starch, glycogen, galactogen, cellulose, the like and/or a combination thereof. In a preferred embodiment, the glucose-derived polysaccharide is a beta-cyclodextrin (BCD). A tetramine is a chemical compound that contains four amine groups. In some embodiments, the tetramine has two secondary amine groups and two primary amine groups, where the primary amine groups are separated from the secondary amine groups by a C2 (two carbon) or C3 (three carbon) aliphatic group. In a preferred embodiment, the tetramine is N,N′-bis(3-aminopropyl)ethylenediamine (BAPEDA). In some embodiments, the phthaloyl chloride is a terephthaloyl chloride (TPC) or a trimesoyl chloride (TMC). In a preferred embodiment, the phthaloyl chloride is TPC. In yet another embodiment, the phthaloyl chloride is TMC. In some embodiments, the units of the tetramine and the units of the phthaloyl chloride are further reacted to form a polyamide (PA). During this process, an interfacial polymerization (IP) reaction occurs where the tetramine in the second layer covalently cross-links with reacted units of the phthaloyl chloride to form a PA. In some embodiments, the tetramine covalently cross-links with the TPC during the interfacial polymerization process to form a PA. In some embodiments, units of glucose-derived polysaccharide are covalently bonded to the PA through reacted units of the phthaloyl chloride. In some embodiments, a reacted hydroxyl group of the glucose-derived polysaccharide is cross-linked to a reacted secondary amine of the reacted units of the tetramine in the PA through a reacted unit of the phthaloyl chloride.

In some embodiments, the second layer is in the form of nanoparticles, preferably a continuous layer of nanoparticles, with a diameter of 2-50 nm, 3-49 nm, preferably 4-48 nm, preferably 5-47 nm, preferably 6-46 nm, preferably 7-45 nm, preferably 8-44 nm, preferably 9-43 nm, preferably 10-42 nm, preferably 11-41 nm, preferably 12-40 nm, preferably 13-39 nm, preferably 14-38 nm, preferably 15-37 nm, preferably 16-36 nm, preferably 17-35 nm, preferably 18-34 nm, preferably 19-33 nm, preferably 20-32 nm, preferably 21-31 nm, preferably 22-30 nm, preferably 23-29 nm, preferably 24-28 nm, or preferably 25-27 nm.

In an embodiment, the second layer has a thickness of 0.050-100 μm, preferably 0.100-50 μm, preferably 0.200-20 μm, 0.400-15 μm, preferably 0.500-10 μm, preferably 0.800-5 μm, preferably 0.900-2 μm, or preferably 1-1.5 μm.

In some embodiments, the nanoparticles form ridges and valleys. In some embodiments, the ridges are 1-3 μm, preferably 1.5-2.5 μm, in width and 1-20 μm, preferably 2-19 μm, preferably 3-18 μm, preferably 4-17 μm, preferably 5-16 μm, preferably 6-15 μm, preferably 7-14 μm, preferably 8-13 μm, preferably 9-12 μm, or preferably 10-11 μm, in length. In some embodiments, the valleys are 0.2-2 μm, preferably 0.4-1.8 μm, preferably 0.6-1.6 μm, preferably 0.8-1.4 μm, and preferably 1.0-1.2 μm in width and 1-20 μm, preferably 2-19 μm, preferably 3-18 μm, preferably 4-17 μm, preferably 5-16 μm, preferably 6-15 μm, preferably 7-14 μm, preferably 8-13 μm, preferably 9-12 μm, or preferably 10-11 μm, in length.

In some embodiments, the second layer is porous with pores which are 100-1000 nm, preferably 125-975 nm, preferably 150-950 nm, preferably 175-925 nm, preferably 200-900 nm, preferably 225-875 nm, preferably 250-850 nm, preferably 275-825 nm, preferably 300-800 nm, preferably 325-775 nm, preferably 350-750 nm, preferably 375-725 nm, preferably 400-700 nm, preferably 425-675 nm, preferably 450-650 nm, preferably 475-625 nm, preferably 500-600 nm, or preferably 525-575 nm in diameter.

In some embodiments, the membrane includes carbon in an amount of 65-75 wt. %, preferably 66-74 wt. %, preferably 67-73 wt. %, preferably 68-72 wt. %, and preferably 69-71 wt. %, oxygen in an amount of 10-15 wt. %, preferably 11-14 wt. %, preferably 12-13 wt. %, sulfur in an amount of 5-10 wt. %, preferably 6-9 wt. %, preferably 7-8 wt. %, and nitrogen in an amount of 5-15 wt. %, preferably 6-14 wt. %, preferably 7-13 wt. %, preferably 8-12 wt. %, and preferably 9-11 wt. %, based on the total weight of the membrane. In a preferred embodiment, the membrane includes carbon in an amount of about 73.1 wt. %, oxygen in an amount of about 12.7%, sulfur in an amount of about 7.2 wt. %, and nitrogen in an amount of about 6.9 wt. %. In yet another embodiment, the membrane includes carbon in an amount of about 70.7 wt. %, oxygen in an amount of about 12.5%, sulfur in an amount of about 6.2 wt. %, and nitrogen in an amount of about 10.7 wt. %.

In some embodiments, the membrane has a WCA of 70-85°, preferably 71-84°, preferably 72-83°, preferably 73-82°, preferably 74-81°, preferably 75-80°, preferably 76-79°, and preferably 77-78°. In a preferred embodiment, the membrane has a WCA of about 80°. In another embodiment, the membrane has a WCA of about 72°.

In some embodiments, the membrane has an average roughness of 5-45 nm, preferably 6-44 nm, preferably 7-43 nm, preferably 8-42 nm, preferably 9-41 nm, preferably 10-40 nm, preferably 11-39 nm, preferably 12-38 nm, preferably 13-37 nm, preferably 14-36 nm, preferably 15-35 nm, preferably 16-34 nm, preferably 17-33 nm, preferably 18-32 nm, preferably 19-31 nm, preferably 20-30 nm, preferably 21-29 nm, preferably 22-28 nm, preferably 23-27 nm, or preferably 24-26 nm.

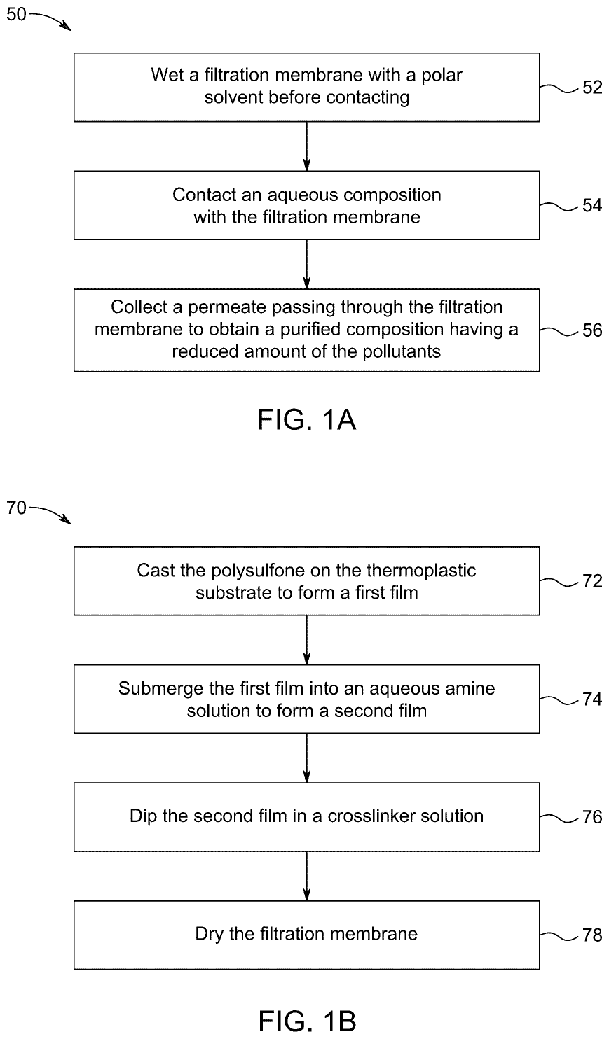

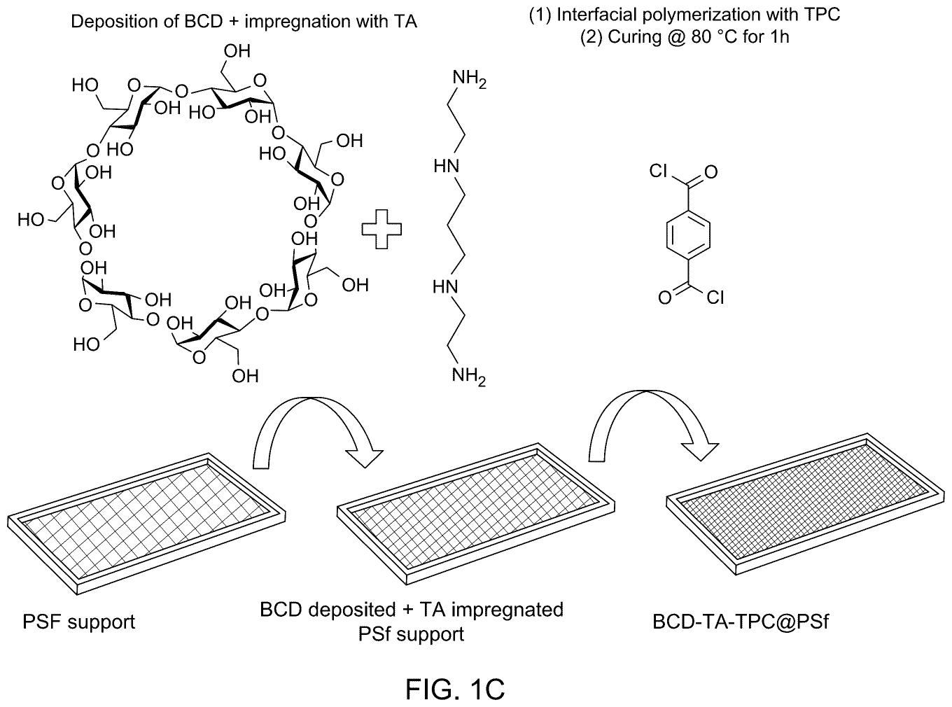

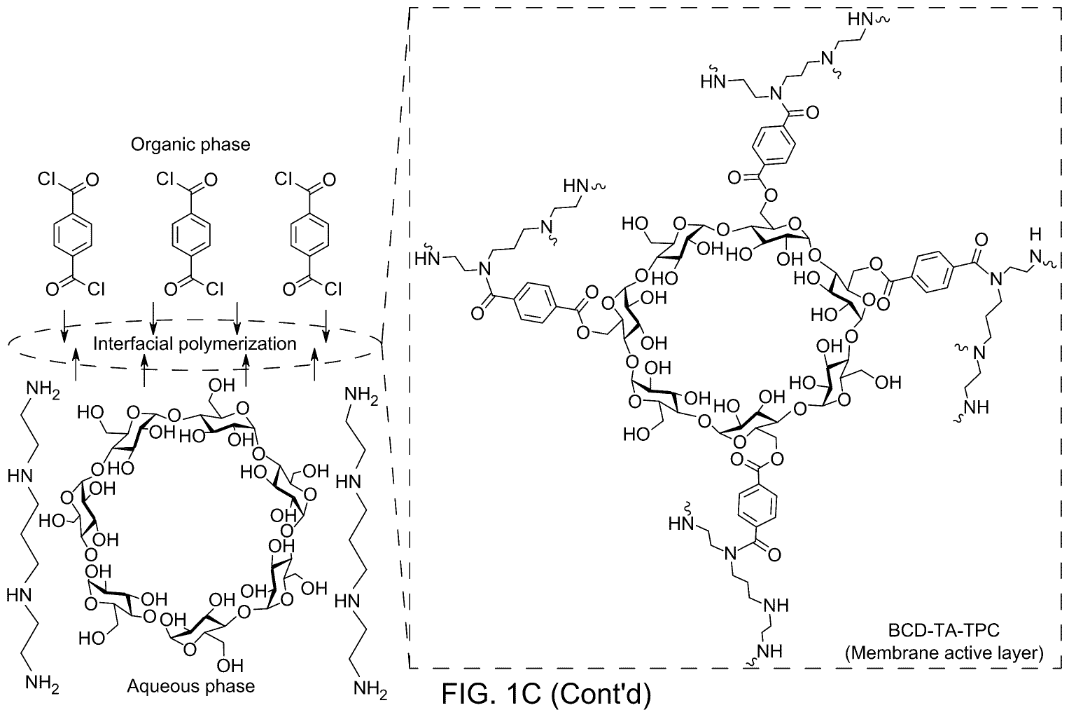

FIG. 1A illustrates a flow chart of a method of nanofiltration. The order in which the method 50 is described is not intended to be construed as a limitation, and any number of the described method steps may be combined in any order to implement the method 50. Additionally, individual steps may be removed or skipped from the method 50 without departing from the spirit and scope of the present disclosure.

At step 52, the method 50 includes wetting the filtration membrane with a polar solvent before contacting. Polar solvents are solvents containing partial positive and partial negative charge. Suitable examples of polar solvents include, but are not limited to, water, methanol, ethanol, acetone, dimethyl sulfoxide (DMSO), dimethylformamide, dimethylacetamide, and isopropanol. In a specific embodiment, the polar solvent is distilled water.

At step 54, the method 50 includes contacting an aqueous composition with the filtration membrane. In some embodiments, the aqueous composition comprises at least water and one or more pollutants. The water may be tap water, distilled water, bi-distilled water, deionized water, deionized distilled water, reverse osmosis water, and/or some other water. In a specific embodiment, the water is distilled water. In some embodiments, the one or more pollutants may include one or more non-polar solvents. Non-polar solvents are solvents that preferably do not contain partial positive and partial negative charge. Polar compounds cannot be dissolved by non-polar solvents, but hydrophobic chemicals can be dissolved by them. Suitable examples of non-polar solvents include, but are not limited to, benzene, hexane, carbon tetrachloride, toluene, diethyl ether, and chloroform.

In some other embodiments, the pollutants include one or more salts and one or more pharmaceuticals. In some embodiments, the salts include magnesium chloride (MgCl₂), calcium chloride (CaCl₂), magnesium sulfate (MgSO₄), sodium sulfate (Na₂SO₄), and sodium chloride (NaCl). In some embodiments, the pharmaceuticals include caffeine, sulfamethoxazole, amitriptyline, and loperamide. In an embodiment, the one or more salts and the one or more pharmaceuticals may include any salts and pharmaceuticals known in the art.

At step 56, the method 50 includes collecting a permeate passing through the filtration membrane to obtain a purified composition having a reduced amount of the pollutants.

In some embodiments, the membrane has a permeate flux of 15-75 L m⁻² h⁻¹ (LMH), preferably 20-70 L m⁻² h⁻¹, preferably 25-65 L m⁻² h⁻¹, preferably 30-60 L m⁻² h⁻¹, preferably 35-55 L m⁻² h⁻¹, preferably 40-50 L m⁻² h⁻¹ at a pressure of 5 bar.

In some embodiments, when the aqueous composition includes water and one or more salts, the membrane has a rejection percentage of 65-95%, preferably 66-94%, preferably 67-93%, preferably 68-92%, preferably 69-91%, preferably 70-90%, preferably 71-89%, preferably 72-88%, preferably 73-87%, preferably 74-86%, preferably 75-85%, preferably 76-84%, preferably 77-83%, preferably 78-82%, and preferably 79-81% by weight based on an initial weight of the one or more salts at a pressure of 15 bar. In one embodiment, the membrane has a rejection percentage of about 80% for Na₂SO₄, about 80% for MgSO₄, about 80% for MgCl₂, and about 80% for CaCl₂ by weight based on an initial weight of the respective salts at a pressure of 15 bar. In another embodiment, the membrane has a rejection percentage of about 93% for Na₂SO₄, about 92% for MgSO₄, about 91% for MgCl₂, and about 84% for CaCl₂ by weight based on an initial weight of the respective salts at a pressure of 15 bar.

In some embodiments, when the aqueous composition includes water and one or more pharmaceuticals, the membrane has a rejection percentage of 65-95%, preferably 66-94%, preferably 67-93%, preferably 68-92%, preferably 69-91%, preferably 70-90%, preferably 71-89%, preferably 72-88%, preferably 73-87%, preferably 74-86%, preferably 75-85%, preferably 76-84%, preferably 77-83%, preferably 78-82%, and preferably 79-81% by weight based on an initial weight of the one or more pharmaceuticals at a pressure of 15 bar. In one embodiment, the membrane has a rejection percentage of about 92% for loperamide, about 85% for amitryptiline, about 70% for sulfamethoxazole, and about 86% for caffeine by weight based on an initial weight of the respective pharmaceuticals at a pressure of 15 bar. In another embodiment, the membrane has a rejection percentage of about 94% for loperamide, about 92% for amitryptiline, about 90% for sulfamethoxazole, and about 88% for caffeine by weight based on an initial weight of the respective pharmaceuticals at a pressure of 15 bar.

FIG. 1B illustrates a flow chart of a method of making the membrane. The order in which the method 70 is described is not intended to be construed as a limitation, and any number of the described method steps can be combined in any order to implement the method 70. Additionally, individual steps may be removed or skipped from the method 70 without departing from the spirit and scope of the present disclosure.

At step 72, the method 70 includes casting the PSf on the thermoplastic substrate to form a first film. In an embodiment, the thermoplastic substrate is polyester terephthalate. In some embodiments, the thermoplastic substrate may be PP, PA, PAN, PC, HDPE, LDPE, PBT, PS, PEEK, PPS, PEI, PAI, PAA, ABS, PLA, PVC, PUR, PVDF, Teflon, and/or a mixture thereof. In some embodiments, blends of thermoplastic polymers may be used. In some embodiments, copolymers may be used along with polyester terephthalate.

At step 74, the method 70 includes submerging the first film into an aqueous amine solution to form a second film. In some embodiments, the aqueous amine solution includes water, the tetramine, and the glucose-derived polysaccharide. In a preferred embodiment, the glucose-derived polysaccharide is a BCD. In a preferred embodiment, the tetramine is BAPEDA. The water may be tap water, distilled water, bidistilled water, deionized water, deionized distilled water, reverse osmosis water, and/or some other water. In a preferred embodiment, the water is distilled water.

At step 76, the method 70 includes dipping the second film in a crosslinker solution. The crosslinker solution includes an organic solvent and the phthaloyl chloride to form the filtration membrane. An organic solvent is a carbon-based substance employed for the dissolution of other substance(s). Suitable examples of organic solvents include methanol, ethanol, acetone, dimethyl sulfoxide (DMSO), dimethylformamide (DMF), dimethylacetamide, isopropanol, benzene, hexane, carbon tetrachloride, toluene, diethyl ether, and chloroform. In a preferred embodiment, the organic solvent is n-hexane. In a preferred embodiment, the phthaloyl chloride is TPC. In another embodiment, the phthaloyl chloride is TMC. In some embodiments, the dipping is from 0.5-5 minutes (min), preferably 1-4.5 minutes, preferably 1.5-4 minutes, preferably 2-3.5 minutes, and preferably about 1 minute, preferably about 2 minutes, or preferably about 3 minutes.

At step 78, the method 70 includes drying the filtration membrane. The drying can be done in air or by using heating appliances, such as ovens, microwaves, autoclaves, hot plates, heating mantles and tapes, oil baths, salt baths, sand baths, air baths, hot-tube furnaces, hot-air guns, or any heating appliance known in the art. In an embodiment, the drying may be done at a temperature of 40 to 200° C., preferably 50 to 150° C., preferably 60 to 100° C., preferably 70 to 90° C., or more preferably about 80° C. In a specific embodiment, the drying of the filtration membrane is done in an oven at about 80° C.

In some embodiments, when the phthaloyl chloride is TPC, the membrane has a rejection percentage of 80-95%, preferably 81-94%, preferably 82-93%, preferably 83-92%, preferably 84-91%, preferably 85-90%, preferably 86-89%, and more preferably 87-88% by weight based on an initial weight of the one or more pollutants at a pressure of 15 bar.

### EXAMPLES

The following examples describe and demonstrate exemplary embodiments of the membrane as described herein. The examples are provided solely for the purpose of illustration and are not to be construed as limitations of the present disclosure, as many variations thereof are possible without departing from the spirit of the present disclosure.

### Example 1: Materials and Methods

Beta-cyclodextrin (BCD), terephthaloyl chloride (TPC), trimesoyl chloride (TMC), polysulfone (PSf), triethylamine (TEA), and N,N′-bis(3-aminopropyl)ethylenediamine (BAPEDA) were purchased from Sigma Aldrich, USA. For the filtration test, different salts (MgCl₂, CaCl₂, MgSO₄, Na₂SO₄, NaCl) and pharmaceutically active compounds (caffeine, sulfamethoxazole, amitriptyline, loperamide) were also bought from Sigma.

The membranes were characterized using attenuated total reflectance Fourier-transform infrared (ATR-FTIR) spectroscopy (Thermo, Smart iTR NICOLET iS10, manufactured by ThermoFischer Scientific, Waltham, United States), scanning electron microscopy (SEM) (JEOL JSM6610LV, Japan), atomic force microscopy (AFM) (Agilent 550, Netherland), and water contact angle (WCA) (KRUSS DSA25, Hamburg). The feed and permeate solution was tested using a conductivity meter (Ultrameter II, Hanna, United States) for salts and a JASCO V-750 UV-Vis spectrophotometer (manufactured by JASCO, Japan) for pharmaceutically active compounds. The membranes were tested for their performance using the Sterlitech CF042 Membrane test system, United States of America.

### Example 2: Membrane Fabrication

Referring to FIG. 1C, a schematic illustration depicting different stages of fabrication of thin film composite (TFC) NF membranes is illustrated. To evaluate the effect of the crosslinker (TMC vs. TPC) addition of BCD and interfacial polymerization time (1, 2, 3 minutes), six membrane typologies were fabricated. One amine aqueous solution was prepared by keeping the BCD amount constant at 0.1 (w/v) %, TEA amount constant at 4 (w/v) %, and BAPEDA constant at 2 (w/v) %. The resulting solution was probe-sonicated for 15 minutes to homogenize the contents. Two crosslinker solutions were prepared by dissolving TMC or TPC at a concentration of 0.2 (w/v) % in n-hexane for interfacial polymerization. Initially, the PSf layer was cast onto a polyester terephthalate nonwoven fabric via wet phase inversion methodology. Later, it was dipped into the BCD/amine aqueous solution, and impregnation was carried out for 10 minutes using a Cole-Parmer mini rocking shaker. After removing the membrane from the BCD/aqueous amine solutions, the rubber roller was used to sweep off the extra solution. The membranes were then dipped into the crosslinker, either TMC or TPC, for preferably 1 minute, preferably 2 minutes, or preferably 3 minutes. This pattern resulted in six membranes of different typologies that were denoted as BCD-TA-TMC@PSf-X (X stands for 1, 2, and 3 minutes), while the other set was named BCD-TA-TPC@PSf-X (X stands for 1, 2 and 3 minutes). The extra cross-linker solution was washed out by rinsing the membrane with 10 mL of n-hexane. The membranes resulting from the crosslinking of TMC were kept inside the oven at 80° C. for 10 min, whereas the TPC crosslinked membranes were kept for 1 hour at similar temperatures. Before beginning the filtration test, membranes were soaked in distilled water.

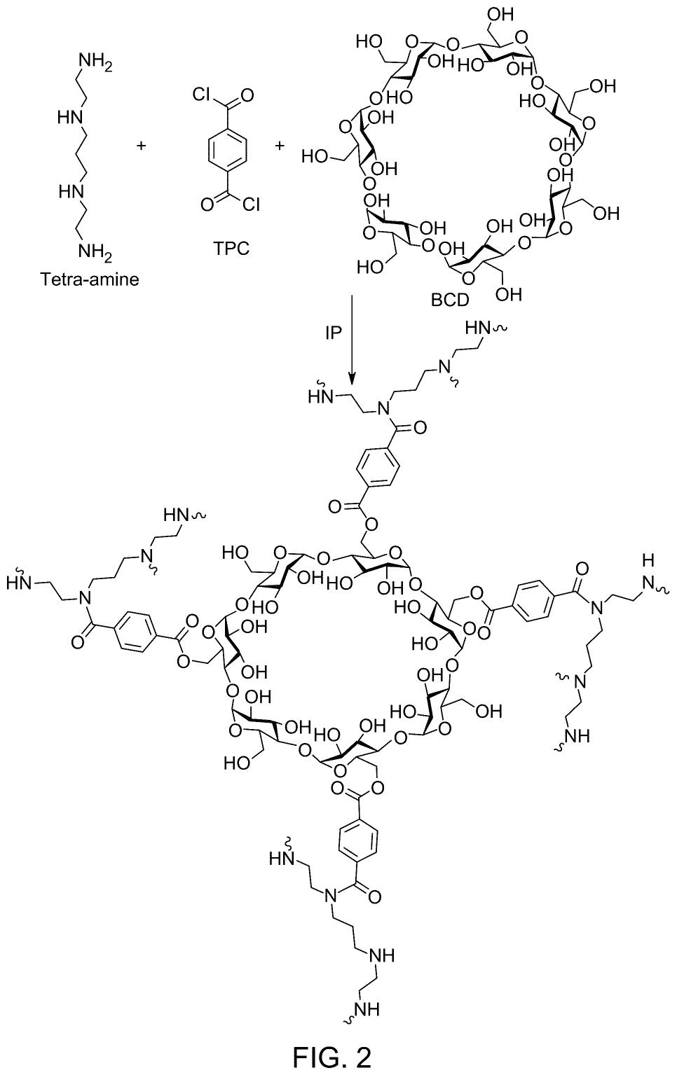

Referring to FIG. 2, a proposed reaction and structure of the active layer using tetramine, TPC, and BCD is illustrated. The active layer was generated by reacting tetramine with TPC and TMC, while BCD was added as an additive during IP. The reaction between amine (—NH/—NH₂) and acid chloride (—COCl) led to the formation of amide linkage (—CONH), leading to PA synthesis. Moreover, hydroxyl groups (—OH) of BCD also react with (—COCl), leading to covalent linkage of BCD in the active layer of the membrane.

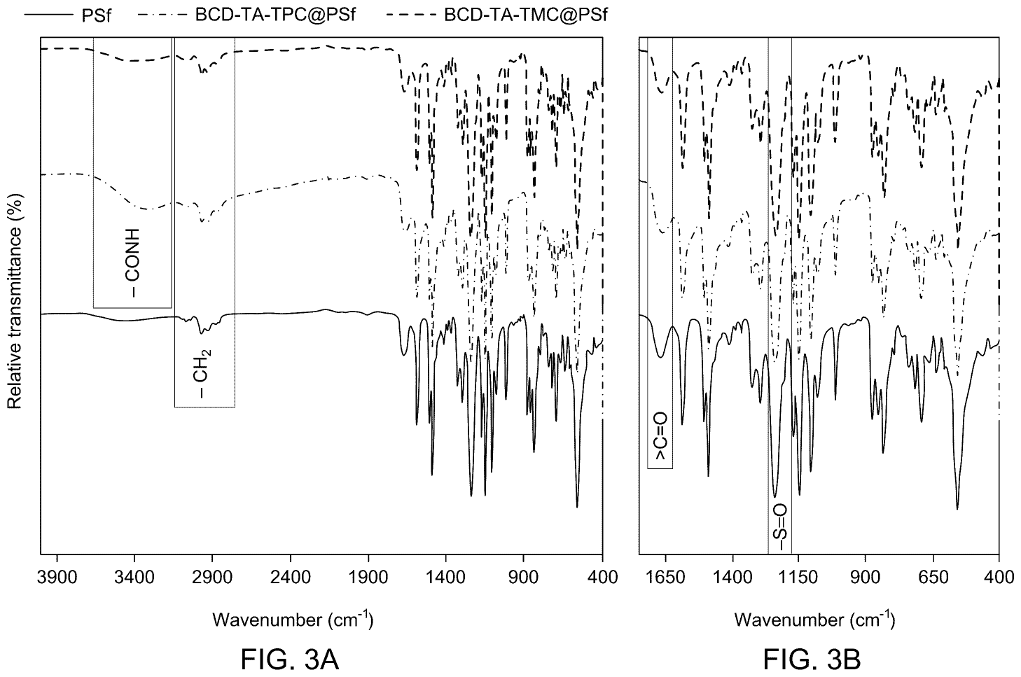

Referring to FIGS. 3A-3B, ATR-FTIR spectra of the NF membrane and PSf support are illustrated. As can be seen from FIG. 3A, to establish the structure of the membranes (BCD-TA-TPC@PSf and BCD-TA-TMC@PSf), a thorough characterization is described herein by the ATR-FTIR. As can be seen from FIG. 3B, ATR-FTIR of a fingerprint region is provided. The peaks are evident in aromatic (3000 cm⁻¹) and aliphatic (2900 cm⁻¹) regions, which are attributed to the benzene rings and —CH₂ groups, respectively, present in PSf and polyester terephthalate support. In the case of BCD-TA-TPC@PSf and BCD-TA-TMC@PSf membranes, a new broad peak spanning from 3600 cm⁻¹ to 3300 cm⁻¹ is evident, which is due to —N—H stretching of newly formed amide (—CONH) linkage in the active layer. Further, the hydroxyl (—OH) groups of the BCD are also overlapped by —N—H stretching of the amide linkage. The presence of several other peaks in the fingerprint region is almost alike in the case of each of the membranes. Furthermore, the peak located at around 1650 cm⁻¹ to 1680 cm⁻¹ can be attributed to carbonyl (>C═O) functional groups of the ester (—COOR) and amide linkages (—CONH). Similarly, the presence of a strong peak at around 1200 cm⁻¹ is due to the —S═O (sulfone) group of the PSf. Hence, ATR-FTIR spectra of all the membranes confirmed the presence of the participating functional groups in the structure of the membranes.

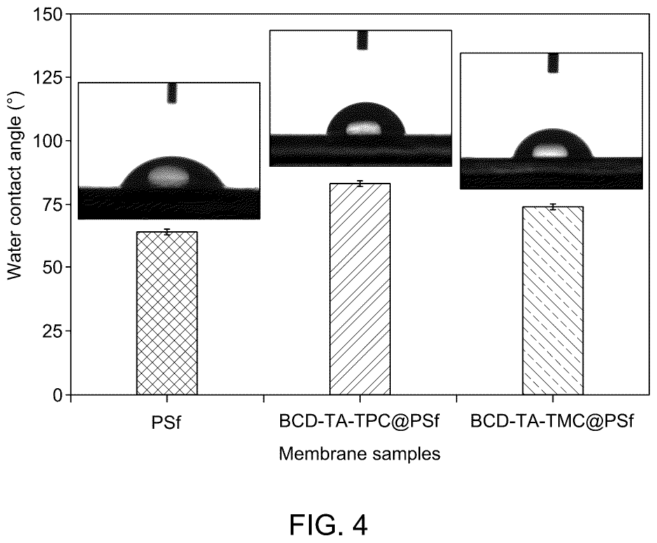

Referring to FIG. 4, a comparison between water contact angles (WCA) for the different membranes is illustrated. Surface hydrophilicity of fabricated membranes is used in understanding the filtration performance of the membranes during filtration experiments. As such, for measuring the surface hydrophilicity of the membranes, WCAs were calculated. The WCA of PSf ultrafiltration support was found to be 65°, and a WCA of 80° was recorded pertaining to the BCD-TA-TPC@PSf membrane. Further, in the case of the BCD-TA-TMC@PSf membrane, the WCA was recorded to be 72°. These observations of varying WCAs of the membranes revealed that each of the membranes are hydrophilic in nature. The variations in WCAs can be explained by considering the hydrolysis of residual acid chloride (—COCl) groups of cross-linkers. TPC has two acid chloride groups, while TMC possesses three acid chloride groups. During IP, when the PA active layer is growing, the TMC can potentially generate more carboxylic (—COOH) groups compared to TPC. The presence of a higher number of —COOH groups in the case of TMC lowers the WCA (72°) in the case of BCD-TA-TMC@PSf compared to the WCA of BCD-TA-TPC@PSf (80°).

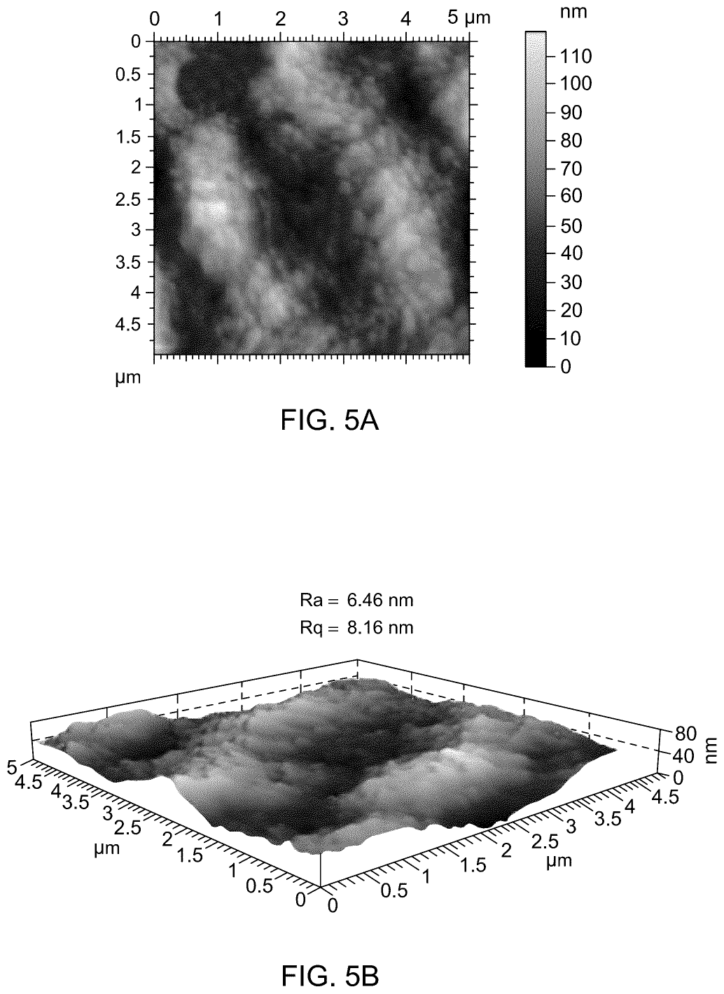

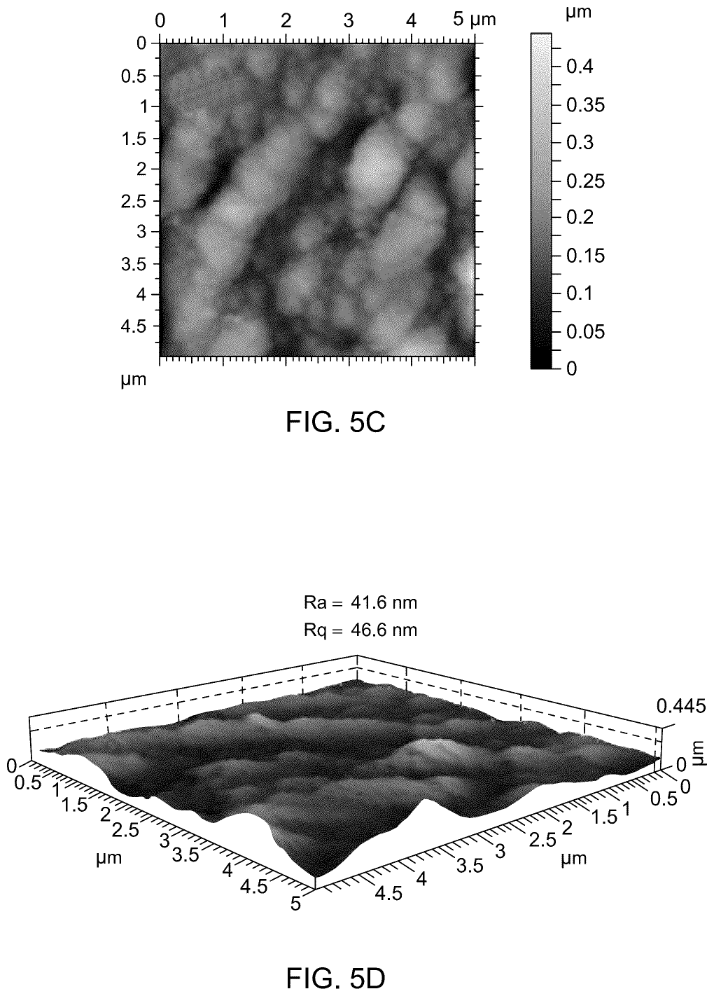

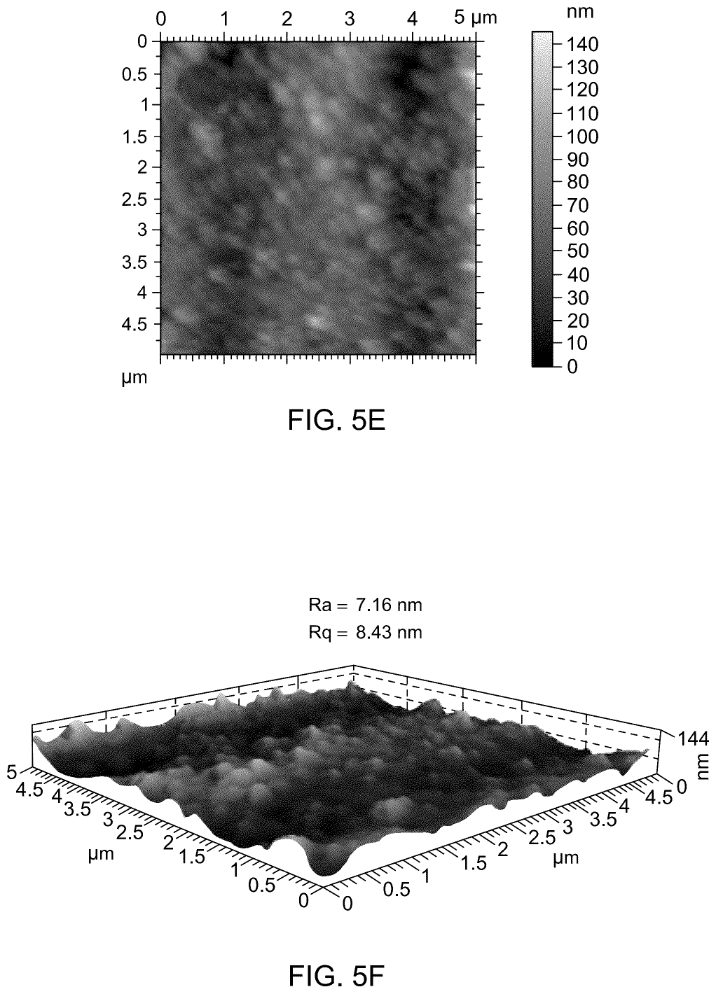

Referring to FIGS. 5A-5F, atomic force microscopy (AFM) topographical images of the PSf support, BCD-TA-TPC@PSf membrane, and the BCD-TA-TPC@PSf membrane are illustrated. AFM is used to measure the surface roughness of membranes, a parameter for understanding the filtration performance of the nanofiltration membranes. As can be seen from FIGS. 5A-5F, the average surface roughness (Ra) and root mean square roughness (Rq) of the PSf support came out to 6.46 nm and 8.16 nm, respectively (FIGS. 5A-5B). These values are low compared to BCD-TA-TPC@PSf (FIGS. 5C-5D) and BCD-TA-TMC@PSf (FIGS. 5E-5F). The Ra and Rq values of the BCD-TA-TPC@PSf were found to be 41.60 nm and 46.6 nm, respectively, while in the case of BCD-TA-TMC@PSf, the values were found to be Ra=7.16 nm and Rq=8.43 nm. The higher values of Ra and Rq in the case of BCD-TA-TPC@PSf have confirmed that the membrane surface has valleys and ridges, providing a greater amplitude during roughness measurements. This ridge and valley conformation contributes to providing appropriate channels during filtration that lead to rejection of salts and other pollutants and permeation of pure water.

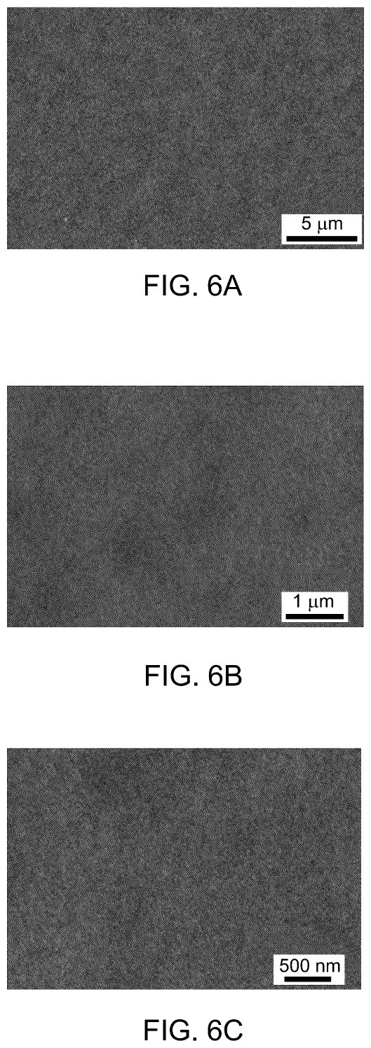

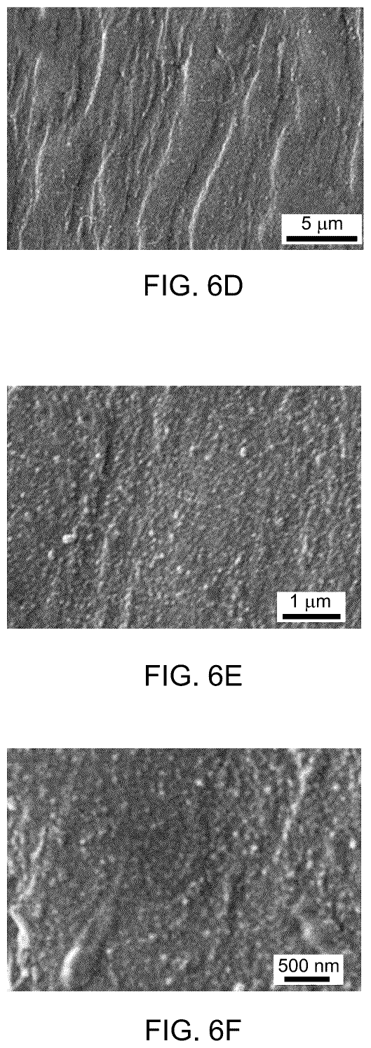

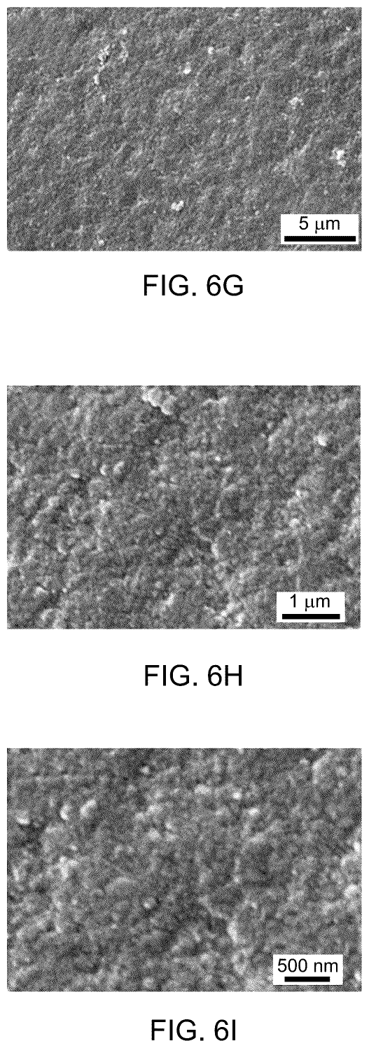

Referring to FIGS. 6A-6C, SEM micrographs of the PSf support, at different magnifications, are illustrated. As can be seen from FIGS. 6A-6C, at different scales (5 μm, 1 μm, and 500 nm), the surface of PSf support appears smooth and highly porous. Referring to FIGS. 6D-6F, SEM micrographs BCD-TA-TPC@PSf membrane, at different magnifications, are illustrated. As can be seen from FIGS. 6D-6F, at different scales (5 μm, 1 μm, and 500 nm), the BCD-TA-TPC@PSf membrane shows the existence of a continuous PA active layer on the PSf support in the form of ridges and valleys. The PSf surface morphology is masked by the PA active layer in case of the BCD-TA-TPC@PSf membrane. Referring to FIGS. 6G-6I, SEM micrographs of the BCD-TA-TMC@PSf membrane are illustrated. As can be seen from the FIGS. 6G-6I, at different scales (5 μm, 1 μm, and 500 nm), the BCD-TA-TMC@PSf membrane showed a foamy texture of the PA active layer. The PA active layer was found to be highly dense and beaded in the case of the BCD-TA-TPC@PSf membrane compared to the BCD-TA-TMC@PSf membrane. These surface morphologies are also augmented by the AFM images of the membranes. The BCD-TA-TPC@PSf membrane has overall features supported for rejecting the salts and permeating clean water, as it has a dense PA active layer with a ridge and valley confirmation (as shown in FIGS. 6D-6F). This is attributed to the extended crosslinking of the tetramine with TPC incorporating BCD as an additive in the active layer.

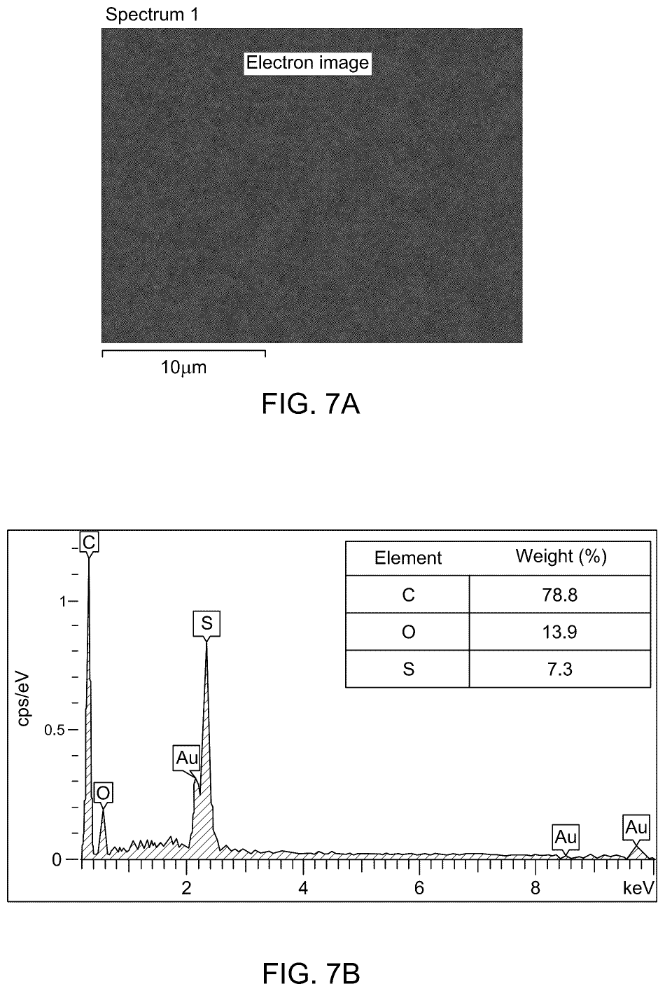

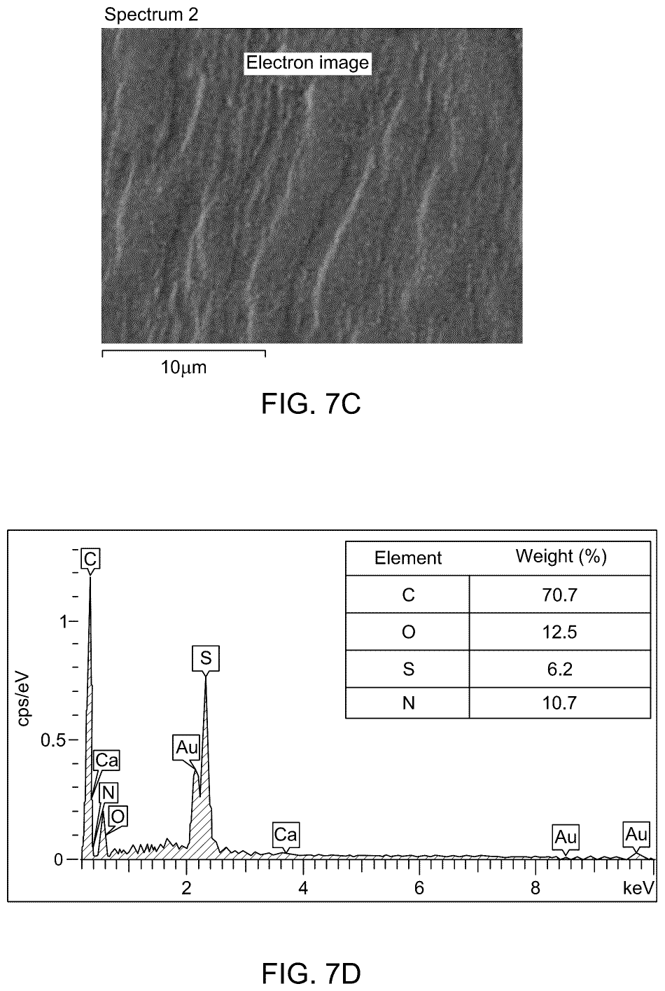

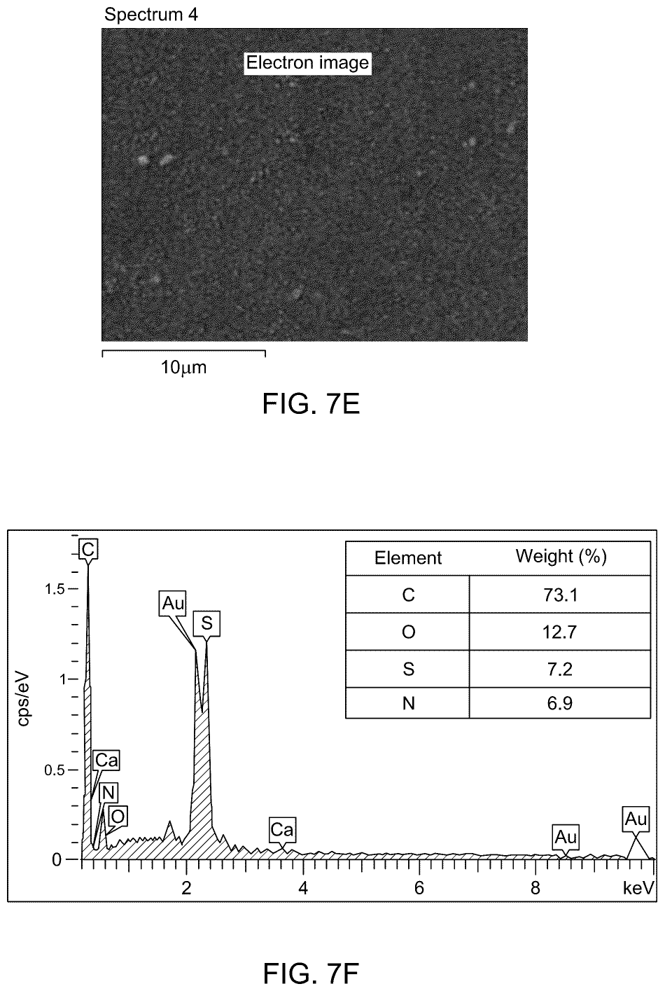

Referring to FIGS. 7A-7B, SEM/EDX analysis results for PSf support are illustrated. As can be seen from FIGS. 7A-7B, the EDX analysis of PSf shows the presence of carbon (C), oxygen (O), and sulfur (S). The presence of C is attributed to aromatic rings, while O and S are due to sulfone (O═S═O) groups of PSf support. Referring to FIGS. 7C-7D, SEM/EDX analysis results for the BCD-TA-TPC@PSf membrane are illustrated. As can be seen from FIGS. 7C-7D, in addition to C, O, and S, an additional element nitrogen (N) was also found, which confirmed the presence of amide (—CONH) groups in the active layer of the membrane. Referring to FIGS. 7E-7F, SEM/EDX analysis results for the BCD-TA-TMC@PSf membrane are illustrated. As can be seen from FIGS. 7E-7F, the BCD-TA-TMC@PSf membrane also shows the same elements (C, O, S, and N) as found for the BCD-TA-TPC@PSf membrane. Although, both BCD-TA-TPC@PSf and BCD-TA-TMC@PSf membranes possessed similar elemental composition, the amount of N was more (10.7 wt. %) for the BCD-TA-TPC@PSf membrane than that of the BCD-TA-TMC@PSf membrane with N percentage of 6.9 wt. %. The observation also suggests that there is a dense PA active layer grown over the PSf support in the case of the BCD-TA-TPC@PSf membrane. The content of C (73.1 wt. %) and O (12.7 wt. %) is more in the case of the BCD-TA-TMC@PSf membrane compared to the BCD-TA-TPC@PSf membrane with C and O percentages of 70.7 wt. % and 12.5 wt. %, respectively. These variations in the composition of the membranes suggest that the BCD-TA-TMC@PSf membrane has relatively more BCD compared to the BCD-TA-TPC@PSf membrane.

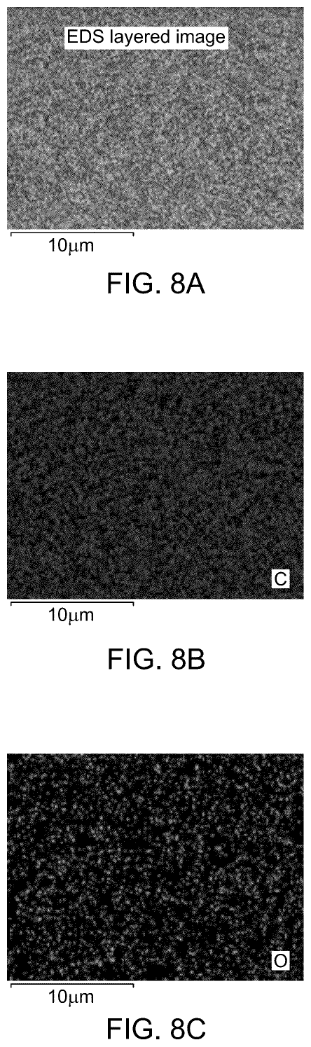

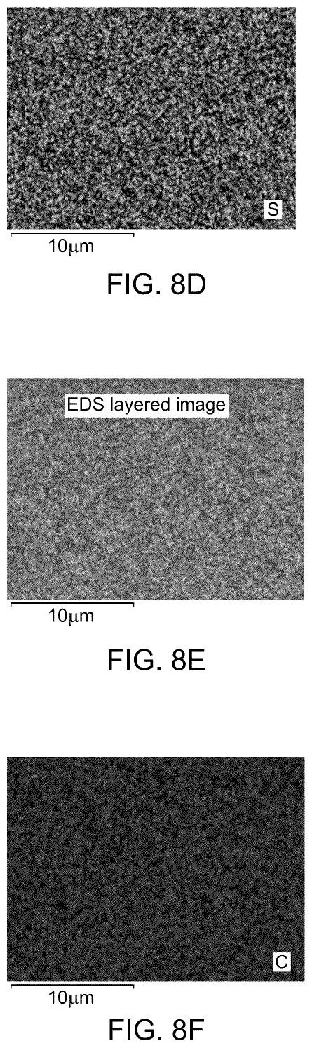

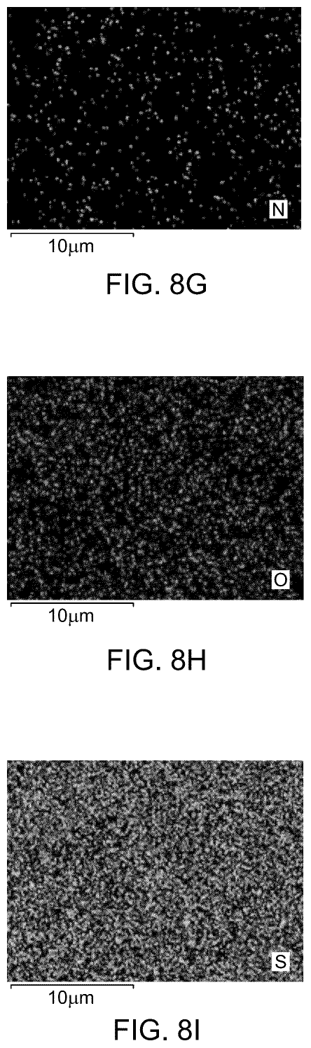

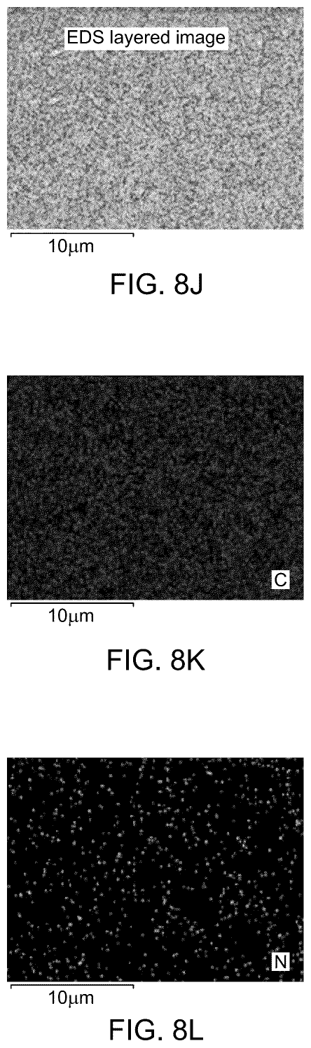

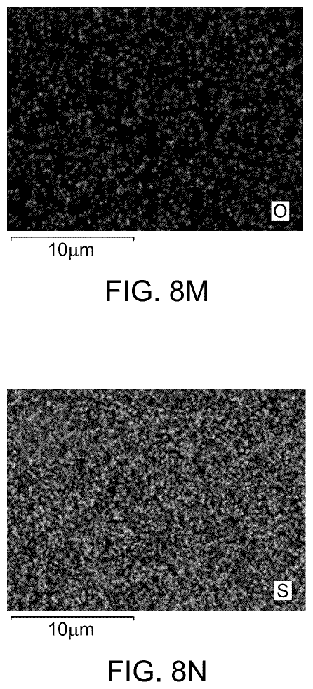

Referring to FIGS. 8A-8D, elemental mapping analysis for the PSf support is illustrated. As can be seen from FIGS. 8B-8D, the elemental mapping analysis depicts that C, O, and S are uniformly distributed throughout the entire area of the PSf support. Referring to FIGS. 8E-8I, elemental mapping analysis for the BCD-TA-TPC@PSf membrane is illustrated. As can be seen from FIGS. 8F-8I, the BCD-TA-TPC@PSf membrane has an additional element, N, detected in addition to C, O, and S, which can be due to the contribution of tetramine to the growth of PA active layer during IP. Referring to FIGS. 8J-8N, elemental mapping analysis for the BCD-TA-TMC@PSf membrane is illustrated. As can be seen from FIGS. 8K-8N, the BCD-TA-TMC@PSf membrane has an additional element, N, detected in addition to C, O, and S, which can be due to the contribution of tetramine to the growth of PA active layer during IP.

The nanofiltration performance of the fabricated membranes was studied by using different feeds containing divalent (Na₂SO₄, MgSO₄, MgCl₂, and CaCl₂), monovalent (NaCl) salts, and micro-pollutants (pharmaceuticals, namely caffeine, sulfamethoxazole, amitriptyline HCl and loperamide HCl). The feeds were prepared by dissolving an appropriate amount of salts or micro-pollutants in distilled water.

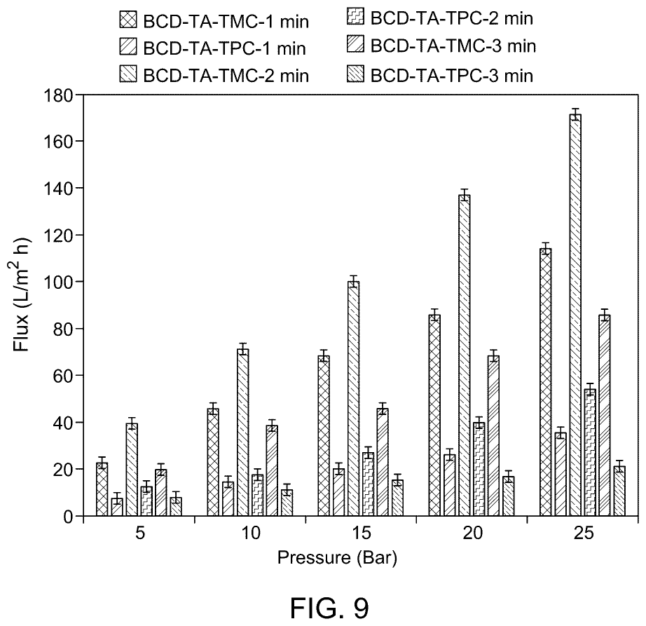

Referring to FIG. 9, a bar graph depicting the variation of permeate flux of BCD-TA-TPC@PSf membranes and BCD-TA-TMC@PSf membranes synthesized at various crosslinking times, at varying applied transmembrane pressure is illustrated. As can be seen from FIG. 9, the highest recorded permeate flux (in L m⁻² h⁻¹) is provided by the BCD-TA-TMC@PSf membrane at a transmembrane pressure of 25 bars. The crosslinking of the BCD-TA-TMC@PSf membrane was 2 minutes. It can also be established from FIG. 9 that the permeate flux has a direct correlation with the transmembrane pressure.

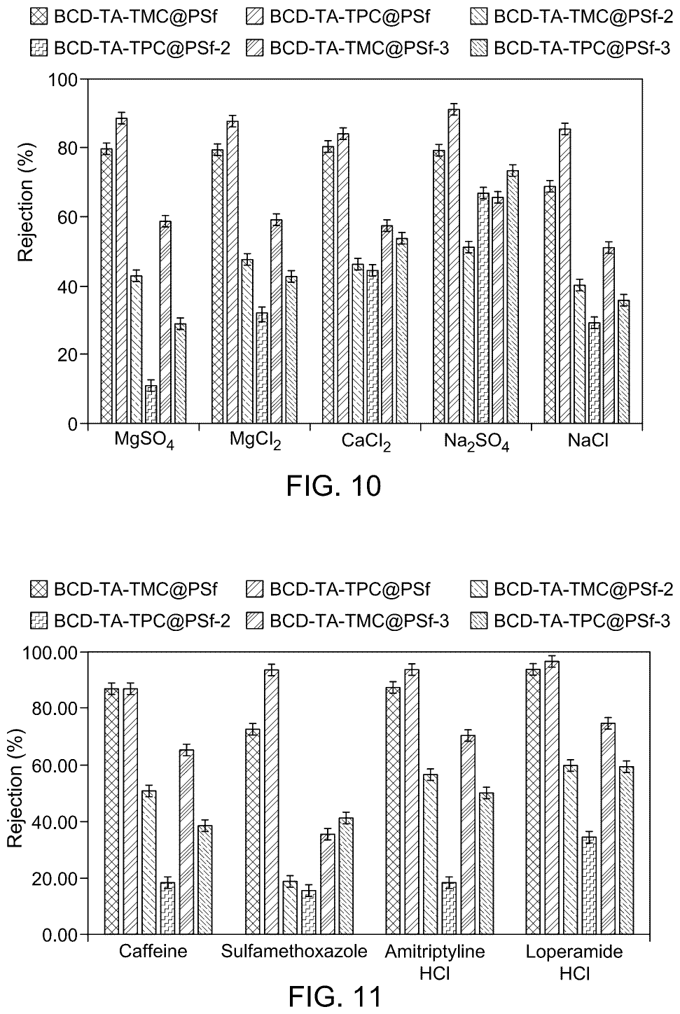

Referring to FIG. 10, a bar graph depicting the rejection percentage of different salts by the BCD-TA-TPC@PSf membranes and BCD-TA-TMC@PSf membranes synthesized at various crosslinking times at 15 bar transmembrane pressure is illustrated. As can be seen from FIG. 10, the highest rejection percentage was recorded by the BCD-TA-TPC@PSf membrane for the Na₂SO₄ salt. It can be noted from FIG. 10, the BCD-TA-TPC@PSf membrane has the highest rejection percentage consistently. The pressure remained constant at 15 bars throughout the course of the experiment.

Referring to FIG. 11, a bar graph depicting the rejection percentage of different micro-pollutants by the BCD-TA-TPC@PSf membranes and the BCD-TA-TMC@PSf membranes synthesized at various crosslinking times at 15 bar transmembrane pressure is illustrated. As can be seen from FIG. 11, the BCD-TA-TPC@PSf membrane has the highest recorded rejection percentage for micro-pollutants, specifically for loperamide HCl. The pressure remained constant at 15 bars throughout the course of the experiment.

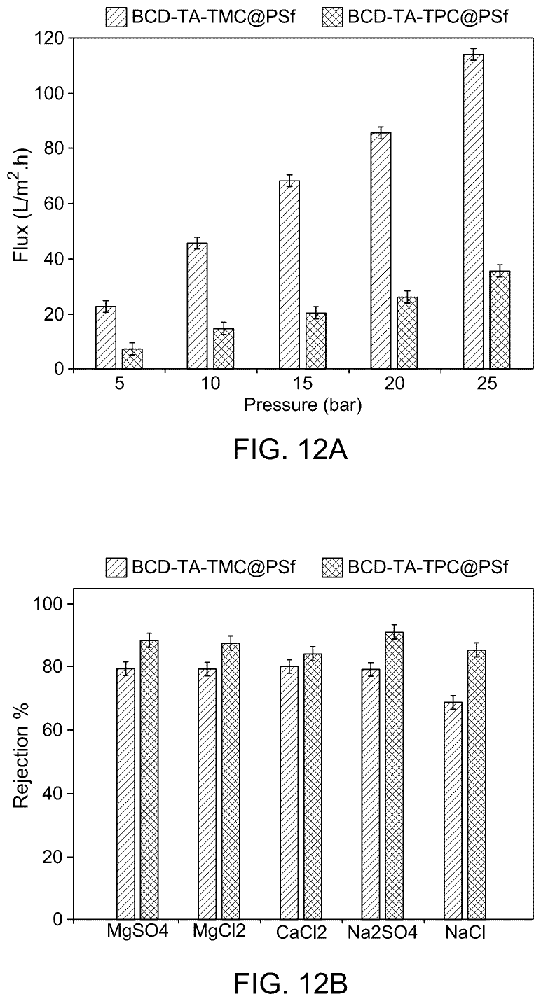

Referring to FIG. 12A, a bar graph depicting the variation of permeate flux as a function of applied feed pressure for the BCD-TA-TPC@PSf membrane and the BCD-TA-TMC@PSf membrane is illustrated. The membranes were installed on a crossflow filtration setup and compacted for an hour by using distilled water as feed. Initially, the effect of pressure on permeate flux was studied, and it was found that the permeate flux increases in a linear manner with increasing transmembrane pressure. As can be seen from FIG. 12A, the best performing membrane was the BCD-TA-TMC@PSf membrane at a transmembrane pressure of 25 bar. The BCD-TA-TMC@PSf membrane showed higher flux compared to the BCD-TA-TPC@PSf membrane. The value of permeate flux of the BCD-TA-TMC@PSf membrane increased from 24 L m⁻² h⁻¹ to 115 L m⁻² h⁻¹ when the transmembrane pressure was increased from 5 bar to 25 bar, respectively. In the case of BCD-TA-TPC@PSf membrane, the flux increased from 8 L m⁻² h⁻¹ to 36 L m⁻² h⁻¹ with an increase in transmembrane pressure from 5 bar to 25 bar.

Referring to FIG. 12B, a bar graph depicting the rejection percentage of salts with the BCD-TA-TMC@PSf and the BCD-TA-TPC@PSf membranes is illustrated. The rejection of Na₂SO₄ was found to be the highest at 93%, compared to the other salts. The salt rejection of Na₂SO₄ was followed by MgSO₄ (92%), MgCl₂ (91%), and CaCl₂ (84%). The lower rejection of CaCl₂ can be attributed to the smaller hydration shell (0.334 nm) of Ca²⁺ ions, compared to Mg²⁺ and SO₄²⁻ ions, which have hydration radii of 0.86 nm and 0.76 nm, respectively. The rejection of salts depends upon the hydration radii of the permeating ions. Hence, the rejection of MgCl₂ and Na₂SO₄ is higher than CaCl₂. In the case of the monovalent salt, the rejection of NaCl was found to be 85%. The rejection of salts was found to be lower for each of the salts in the case of the BCD-TA-TMC@PSf membrane. The rejection and flux performance of the membranes suggest that the BCD-TA-TMC@PSf membrane has a relatively loose PA active layer with a slightly higher concentration of BCD, as confirmed by EDX analysis. The incorporation of BCD led to higher permeate flux, while a slightly loose PA active layer of BCD-TA-TMC@PSf membrane resulted in lower salt rejection. On the other hand, BCD in the dense PA active layer of the BCD-TA-TPC@PSf membrane equips the membrane with reasonable flux and high salt rejection. The increase in permeate flux due to BCD is attributed to the outer hydrophilic sphere of hydroxyl groups on the pyranose moieties of BCD.

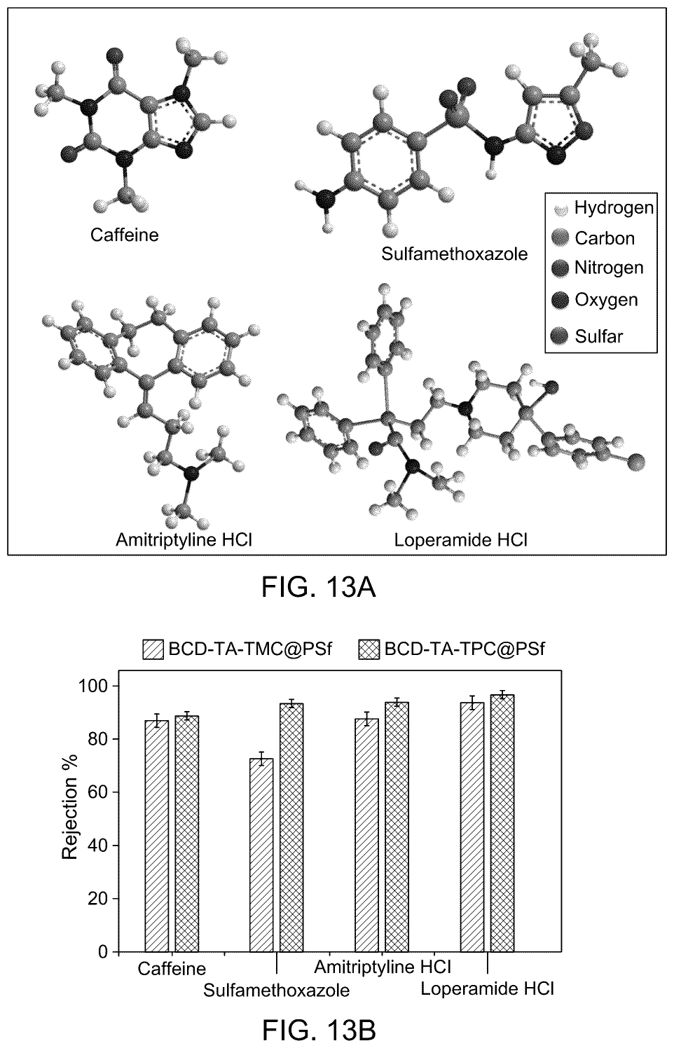

Referring to FIGS. 13A, a schematic diagram of the structure of micropollutants is illustrated, and a subsequent bar graph depicting the rejection profiles of the micropollutants is illustrated in FIG. 13B. As the concentration of different micropollutants, especially pharmaceuticals, is increasing in water bodies at an alarming pace, leading to multidrug-resistant bacterial strains, the rejection of the model drugs (caffeine, sulfamethoxazole, amitriptyline HCl, and loperamide HCl) have been studied. The rejection of drugs is dependent upon the molecular weight of the drugs. Hence, the rejection of drugs by both membranes followed the size-exclusion mechanism. The BCD-TA-TPC@PSf membrane showed the highest rejection of 94 wt. % for loperamide, while a lower rejection of 88 wt. % was observed for caffeine. The rejections of sulfamethoxazole and amitriptyline HCl were found to be 90 wt. % and 92 wt. %, respectively. Like salt rejection, the BCD-TA-TMC@PSf membrane showed lower rejection for micropollutants compared to the BCD-TA-TPC@PSf membrane (FIG. 13B). Table 1 shows a comparison of the performances of BCD-TA-TPC@PSf and BCD-TA-TPC@PSf membranes.

TABLE 1
A comparison of different features of the BCD-TA-TMC@PSf
membrane and BCD-TA-TPC@PSf membrane.

| | Membranes | |
|---|---|---|
| Feeds | BCD-TA-TMC@PSf | BCD-TA-TPC@PSf |
| Salts | Salt Rejections (wt. %) | Salt Rejections (wt. %) |
| Na₂SO₄ | 80 | 93 |
| MgSO₄ | 80 | 92 |
| MgCl₂ | 80 | 91 |
| CaCl₂ | 80 | 84 |
| Pharmaceuticals | Pharmaceuticals | Pharmaceuticals |
| | Rejection (wt. %) | Rejection (wt. %) |
| Loperamide | 92 | 94 |
| Amitriptyline HCl | 85 | 92 |
| Sulfamethoxazole | 70 | 90 |
| Caffeine | 86 | 88 |
| Water | Permeate Flux | Permeate Flux |
| | (L m⁻² h⁻¹) | (L m⁻² h⁻¹) |
| Pure water | 115 | 36 |

The BCD-TA-TMC@PSf and BCD-TA-TPC@PSf thin film composite nanofiltration membranes were successfully fabricated by interfacial polymerization using two different cross-linkers, TPC and TMC, reacted with TA solution containing BCD for desalination and micropollutants removal. ATR-FTIR, SEM, EDS, and elemental mapping analysis of the fabricated membranes demonstrated the effective formation of the PA active layer on the surface of PSf support. The thin film composite nanofiltration membranes fabricated using TPC as a crosslinker in the presence of TA and BCD showed better performance for desalination and micropollutants removal compared to the thin film composite nanofiltration membranes fabricated using TMC as a crosslinker. The BCD-TA-TPC@PSf showed rejections of salts such as Na₂SO₄, MgSO₄, MgCl₂ and CaCl₂ to be 93%, 92%, 91% and 84%, respectively. In the case of BCD-TA-TMC@PSf, the rejections of all the salts Na₂SO₄, MgSO₄, MgCl₂, and CaCl₂ were nearly 80%. The results were similar in the case of pharmaceutical micropollutants with the BCD-TA-TPC@PSf membrane. Higher permeate flux was achieved by integrating BCD in the PA active layer. The BCD-TA-TMC@PSf membrane showed a higher permeate flux of 115 L m⁻² h⁻¹ compared to the BCD-TA-TPC@PSf membrane having a flux of 36 L m⁻² h⁻¹ at 25 bar, which might be due to the formation of slightly loose PA active layer with TMC and TA in the presence of BCD. However, due to the formation of a dense PA active layer with TPC and TA in the presence of BCD, the BCD-TA-TPC@PSf membrane showed reasonable flux and a high level of salts and drug rejections.

Numerous modifications and variations of the present disclosure are possible in light of the above teachings. It is therefore to be understood that within the scope of the appended claims, the disclosure may be practiced otherwise than as specifically described herein.

1: A filtration membrane, comprising, in the following order:
a thermoplastic substrate,
a first layer comprising a polysulfone,
a second layer comprising units of a glucose-derived polysaccharide reacted with units of a tetramine and units of a phthaloyl chloride,
wherein the units of the tetramine and the units of the phthaloyl chloride are further reacted to form a polyamide,
wherein units of glucose-derived polysaccharide are covalently bonded to the polyamide through reacted units of the phthaloyl chloride.

2: The filtration membrane of claim 1, wherein the thermoplastic substrate is a polyester terephthalate.

3: The filtration membrane of claim 1, wherein the glucose-derived polysaccharide is a beta-cyclodextrin (BCD).

4: The filtration membrane of claim 1, wherein the tetramine is N,N′-bis(3-aminopropyl)ethylenediamine.

5: The filtration membrane of claim 1, wherein the phthaloyl chloride is terephthaloyl chloride or trimesoyl chloride.

6: The filtration membrane of claim 1, wherein a reacted hydroxyl group of the glucose-derived polysaccharide is cross-linked to a reacted secondary amine of the reacted units of the tetramine in the polyamide through a reacted unit the phthaloyl chloride.

7: The filtration membrane of claim 1, wherein the membrane has a water contact angle of 700 to 85°.

8: The filtration membrane of claim 1, wherein the membrane has an average surface roughness of 5 to 45 nm.

9: The filtration membrane of claim 1, wherein the second layer is in the form of nanoparticles with a diameter of 2 nm to 50 nm.

10: The filtration membrane of claim 9, wherein the nanoparticles form ridges 1 μm to 3 μm in width and 1 μm to 20 μm in length and valleys 0.2 μm to 2 μm in width and 1 μm to 20 μm in length.

11: The filtration membrane of claim 1, wherein the second layer is porous with pores 100 nm to 1000 nm in diameter.

12: The filtration membrane of claim 1, wherein the membrane comprises carbon in an amount of 65 wt. % to 75 wt. %, oxygen in an amount of 10 wt. % to 15 wt. %, sulfur in an amount of 5 wt. % to 10 wt. %, and nitrogen in an amount of 5 wt. % to 15 wt. % based on a total weight of the membrane.

13: A nanofiltration method, comprising:
contacting an aqueous composition with the filtration membrane of claim 1,
wherein the aqueous composition comprises at least water and one or more pollutants,
wherein the pollutants comprise one or more salts and one or more pharmaceuticals,
collecting a permeate passing through the filtration membrane to obtain a purified composition having a reduced amount of the pollutants.

14: The method of claim 13, further comprising:
wetting the filtration membrane with a polar solvent before the contacting.

15: The filtration membrane of claim 1, wherein the membrane has a permeate flux of 15 L m⁻² h⁻¹ to 75 L m⁻² h⁻¹ at a pressure of 5 bar.

16: The method of claim 13, wherein the aqueous composition comprises water and one or more salts, and has a rejection percentage of 65% to 95% by weight based on an initial weight of the one or more salts at a pressure of 15 bar.

17: The method of claim 13, wherein the aqueous composition comprises water and one or more pharmaceuticals, and has a rejection percentage of 65 to 95% by weight based on an initial weight of the one or more pharmaceuticals at a pressure of 15 bar.

18: The filtration membrane of claim 1, wherein the membrane is made by a process comprising:
casting the polysulfone on the thermoplastic substrate to form a first film;
submerging the first film into an aqueous amine solution to form a second film,
wherein the aqueous amine solution comprises water, the tetramine, and the glucose-derived polysaccharide,
dipping the second film in a crosslinker solution,
wherein the crosslinker solution comprises an organic solvent and the phthaloyl chloride to form the filtration membrane,
drying the filtration membrane.

19: The filtration membrane of claim 18, wherein the dipping is from 0.5 minutes (min) to 5 min.

20: The method of claim 13, wherein the phthaloyl chloride is a terephthaloyl chloride, and the membrane has a rejection percentage of 80% to 95% by weight based on an initial weight of the one or more pollutants at a pressure of 15 bar.
